(19) United States
(12) Patent Application Publication
(10) Pub. No.: US 2025/0249909 A1
(43) Pub. Date: Aug. 7, 2025

(54) OBJECT ORIENTATION DETERMINATION FROM MAP AND GROUP PARAMETERS

(71) Applicant: Motional AD LLC, Boston, MA (US)

(72) Inventors: Holger CAESAR, Singapore (SG); Edouard Francois Marc CAPELLIER, Singapore (SG)

(21) Appl. No.: 19/043,111

(22) Filed: Jan. 31, 2025

Related U.S. Application Data
(63) Continuation of application No. PCT/US2023/029135, filed on Jul. 31, 2023.
(60) Provisional application No. 63/394,316, filed on Aug. 2, 2022.

(51) Int. Cl. B60W 40/02; B60W 60/00

(52) U.S. Cl. CPC B60W 40/02; B60W 60/001; B60W 2554/4041; B60W 2556/40

(57) ABSTRACT

Provided are methods for object orientation determination, which can include obtaining map parameters and group parameters and determining orientation data using said map and group parameters. Some methods described also include obtaining sensor data and using the sensor data for the determination of orientation data. Systems and computer program products are also provided.

### PRIORITY CLAIM

This application is a continuation of International Patent Application No. PCT/US2023/029135, filed on Jul. 31, 2023, entitled “OBJECT ORIENTATION DETERMINATION FROM MAP AND GROUP PARAMETERS” which claims the priority benefit of U.S. Provisional Patent Application No. 63/394,316, entitled OBJECT ORIENTATION DETERMINATION FROM MAP AND GROUP PARAMETERS, filed on Aug. 2, 2022. Each of the above-referenced applications is hereby incorporated herein by reference in its entirety.

### BRIEF DESCRIPTION OF THE FIGURES

FIG. 1 is an example environment in which a vehicle including one or more components of an autonomous system can be implemented.

FIG. 2 is a diagram of one or more example systems of a vehicle including an autonomous system.

FIG. 3 is a diagram of components of one or more example devices and/or one or more example systems of FIGS. 1 and 2.

FIG. 4A is a diagram of certain components of an example autonomous system;

FIG. 4B is a diagram of an example implementation of a neural network.

FIGS. 4C and 4D are a diagram illustrating example operation of a convolutional neural network, CNN.

FIG. 5 is a diagram of an example implementation of a process for object orientation determination.

FIG. 6 is a diagram of an example implementation of a process for object orientation determination.

FIGS. 7A-7B are diagrams of an example implementation of a process for object orientation determination.

FIG. 8 is a flowchart of an example process for object orientation determination.

FIG. 9 is a block diagram of example processes within an AV compute system and data flow between the AV compute and related systems and components.

FIG. 10A is diagram illustrating examples of map and group parameters that can be used by the AV compute system shown in FIG. 5 or FIG. 9, to determine orientations and/or positions of one or more objects.

FIG. 10B is a diagram illustrating a perception of an environment surrounding an AV based on senor data and arrangement of objects prior to generation of orientation data.

### DETAILED DESCRIPTION

In the following description numerous specific details are set forth in order to provide a thorough understanding of the present disclosure for the purposes of explanation. It will be apparent, however, that the embodiments described by the present disclosure can be practiced without these specific details. In some instances, well-known structures and devices are illustrated in block diagram form in order to avoid unnecessarily obscuring aspects of the present disclosure.

Specific arrangements or orderings of schematic elements, such as those representing systems, devices, modules, instruction blocks, data elements, and/or the like are illustrated in the drawings for ease of description. However, it will be understood by those skilled in the art that the specific ordering or arrangement of the schematic elements in the drawings is not meant to imply that a particular order or sequence of processing, or separation of processes, is required unless explicitly described as such. Further, the inclusion of a schematic element in a drawing is not meant to imply that such element is required in all embodiments or that the features represented by such element may not be included in or combined with other elements in some embodiments unless explicitly described as such.

Further, where connecting elements such as solid or dashed lines or arrows are used in the drawings to illustrate a connection, relationship, or association between or among two or more other schematic elements, the absence of any such connecting elements is not meant to imply that no connection, relationship, or association can exist. In other words, some connections, relationships, or associations between elements are not illustrated in the drawings so as not to obscure the disclosure. In addition, for ease of illustration, a single connecting element can be used to represent multiple connections, relationships or associations between elements. For example, where a connecting element represents communication of signals, data, or instructions (e.g., “software instructions”), it should be understood by those skilled in the art that such element can represent one or multiple signal paths (e.g., a bus), as may be needed, to affect the communication.

Although the terms first, second, third, and/or the like are used to describe various elements, these elements should not be limited by these terms. The terms first, second, third, and/or the like are used only to distinguish one element from another. For example, a first contact could be termed a second contact and, similarly, a second contact could be termed a first contact without departing from the scope of the described embodiments. The first contact and the second contact are both contacts, but they are not the same contact.

The terminology used in the description of the various described embodiments herein is included for the purpose of describing particular embodiments only and is not intended to be limiting. As used in the description of the various described embodiments and the appended claims, the singular forms “a,” “an” and “the” are intended to include the plural forms as well and can be used interchangeably with “one or more” or “at least one,” unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this description specify the presence of stated features, integers, steps, operations, elements, and/or components, but do not preclude the presence or addition of one or more other features, integers, steps, operations, elements, components, and/or groups thereof.

As used herein, the terms “communication” and “communicate” refer to at least one of the reception, receipt, transmission, transfer, provision, and/or the like of information (or information represented by, for example, data, signals, messages, instructions, commands, and/or the like). For one unit (e.g., a device, a system, a component of a device or system, combinations thereof, and/or the like) to be in communication with another unit means that the one unit is able to directly or indirectly receive information from and/or send (e.g., transmit) information to the other unit. This may refer to a direct or indirect connection that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit (e.g., a third unit located between the first unit and the second unit) processes information received from the first unit and transmits the processed information to the second unit. In some embodiments, a message may refer to a network packet (e.g., a data packet and/or the like) that includes data.

As used herein, the term “if” is, optionally, construed to mean “when”, “upon”, “in response to determining,” “in response to detecting,” and/or the like, depending on the context. Similarly, the phrase “if it is determined” or “if [a stated condition or event] is detected” is, optionally, construed to mean “upon determining,” “in response to determining,” “upon detecting [the stated condition or event],” “in response to detecting [the stated condition or event],” and/or the like, depending on the context. Also, as used herein, the terms “has”, “have”, “having”, or the like are intended to be open-ended terms. Further, the phrase “based on” is intended to mean “based at least partially on” unless explicitly stated otherwise.

“At least one,” and “one or more” includes a function being performed by one element, a function being performed by more than one element, e.g., in a distributed fashion, several functions being performed by one element, several functions being performed by several elements, or any combination of the above.”

Some embodiments of the present disclosure are described herein in connection with a threshold. As described herein, satisfying, such as meeting, a threshold can refer to a value being greater than the threshold, more than the threshold, higher than the threshold, greater than or equal to the threshold, less than the threshold, fewer than the threshold, lower than the threshold, less than or equal to the threshold, equal to the threshold, and/or the like.

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments can be practiced without these specific details. In other instances, well-known methods, procedures, components, circuits, and networks have not been described in detail so as not to unnecessarily obscure aspects of the embodiments.

### General Overview

LiDAR-based object detectors can be used in autonomous vehicles for predicting a bounding box for objects, agents, and actors, such as vehicles, in the environment that the autonomous vehicle is operating in. An autonomous vehicle can perform this task relatively easily with a dense LiDAR point cloud, but has a difficult task when receiving a sparse point cloud, for example due to distant objects or partial occlusion.

In particular, it can be difficult for an autonomous vehicle to determine the exact position and orientation of other vehicles in the environment, and identifying the front or back of a vehicle is especially challenging. For dynamic vehicles, the autonomous vehicle can infer the front and back of the vehicle from object motion but may still not have the necessary accuracy. For static vehicles, object motion cannot be used by the autonomous vehicle, making determinations even more difficult.

In some aspects and/or embodiments, systems, methods, and computer program products described herein include and/or implement object orientation determination. A method includes obtaining using at least one processor, a map parameter indicative of a predetermined position of a first object in an environment where an autonomous vehicle is configured to operate. A method includes obtaining, using the at least one processor, a group parameter indicative of a predetermined relation between objects of a group, wherein the environment comprises the objects. A method includes determining, using the at least one processor, based on the map parameter and the group parameter, orientation data indicative of an orientation of at least one object amongst the first object and the objects. A method includes causing, using the at least one processor, object detection data associated with the at least one object to be provided to a device based on the orientation data, wherein the object detection data is indicative of detection of one or more spatial features of the at least one object.

By virtue of the implementation of systems, methods, and computer program products described herein, techniques for object orientation determination advantageously include improving object detection and/or object tracking of an autonomous vehicle. For example, the disclosed techniques can improve on sparse LIDAR cloud detection in the determination of the position, dimension and orientation of an object. Advantageously, the techniques can be incorporated into one or more points in object labeling pipelines, which include object detection, object tracking, and post-processing steps. The disclosed techniques can be advantageously used to improve the performances (e.g., quality of outputs) of neural network models when estimating object orientations, dimensions, and locations.

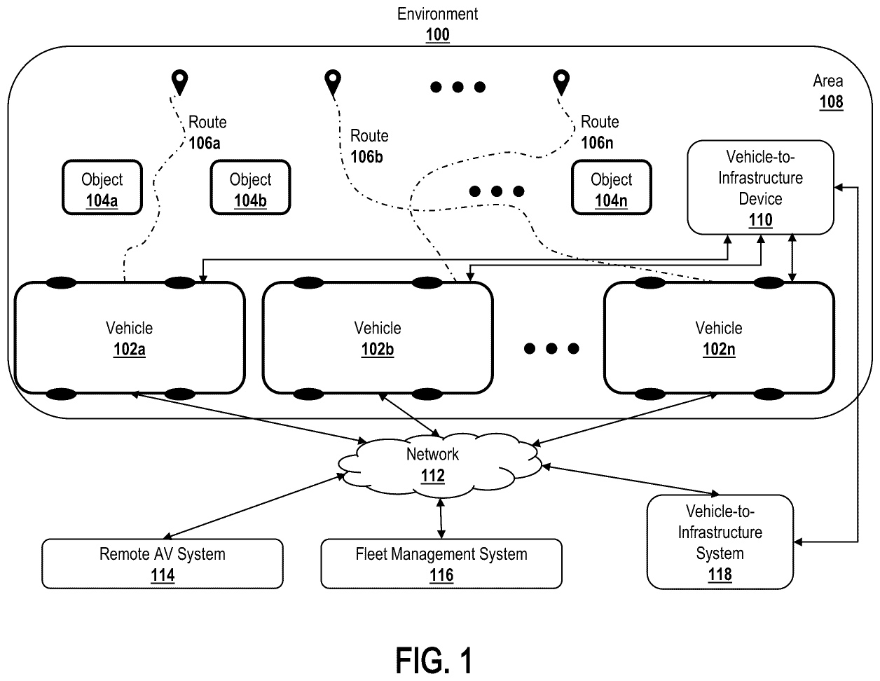

Referring now to FIG. 1, illustrated is example environment 100 in which vehicles that include autonomous systems, as well as vehicles that do not, are operated. As illustrated, environment 100 includes vehicles 102a-102n, objects 104a-104n, routes 106a-106n, area 108, vehicle-to-infrastructure (V2I) device 110, network 112, remote autonomous vehicle (AV) system 114, fleet management system 116, and V2I system 118. Vehicles 102a-102n, vehicle-to-infrastructure (V2I) device 110, network 112, autonomous vehicle (AV) system 114, fleet management system 116, and V2I system 118 interconnect (e.g., establish a connection to communicate and/or the like) via wired connections, wireless connections, or a combination of wired or wireless connections. In some embodiments, objects 104a-104n interconnect with at least one of vehicles 102a-102n, vehicle-to-infrastructure (V2I) device 110, network 112, autonomous vehicle (AV) system 114, fleet management system 116, and V2I system 118 via wired connections, wireless connections, or a combination of wired or wireless connections.

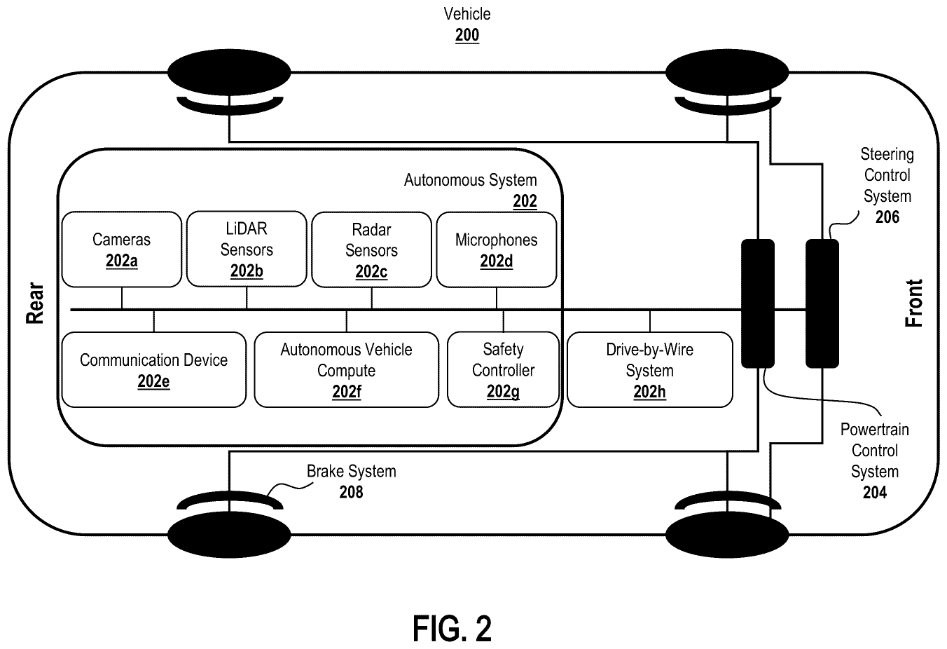

Vehicles 102a-102n (referred to individually as vehicle 102 and collectively as vehicles 102) include at least one device configured to transport goods and/or people. In some embodiments, vehicles 102 are configured to be in communication with V2I device 110, remote AV system 114, fleet management system 116, and/or V2I system 118 via network 112. In some embodiments, vehicles 102 include cars, buses, trucks, trains, and/or the like. In some embodiments, vehicles 102 are the same as, or similar to, vehicles 200, described herein (see FIG. 2). In some embodiments, a vehicle 200 of a set of vehicles 200 is associated with an autonomous fleet manager. In some embodiments, vehicles 102 travel along respective routes 106a-106n (referred to individually as route 106 and collectively as routes 106), as described herein. In some embodiments, one or more vehicles 102 include an autonomous system (e.g., an autonomous system that is the same as or similar to autonomous system 202).

Objects 104a-104n (referred to individually as object 104 and collectively as objects 104) include, for example, at least one vehicle, at least one pedestrian, at least one cyclist, at least one structure (e.g., a building, a sign, a fire hydrant, etc.), and/or the like. Each object 104 is stationary (e.g., located at a fixed location for a period of time) or mobile (e.g., having a velocity and associated with at least one trajectory). In some embodiments, objects 104 are associated with corresponding locations in area 108.

Routes 106a-106n (referred to individually as route 106 and collectively as routes 106) are each associated with (e.g., prescribe) a sequence of actions (also known as a trajectory) connecting states along which an AV can navigate. Each route 106 starts at an initial state (e.g., a state that corresponds to a first spatiotemporal location, velocity, and/or the like) and ends at a final goal state (e.g., a state that corresponds to a second spatiotemporal location that is different from the first spatiotemporal location) or goal region (e.g. a subspace of acceptable states (e.g., terminal states)). In some embodiments, the first state includes a location at which an individual or individuals are to be picked-up by the AV and the second state or region includes a location or locations at which the individual or individuals picked-up by the AV are to be dropped-off. In some embodiments, routes 106 include a plurality of acceptable state sequences (e.g., a plurality of spatiotemporal location sequences), the plurality of state sequences associated with (e.g., defining) a plurality of trajectories. In an example, routes 106 include only high level actions or imprecise state locations, such as a series of connected roads dictating turning directions at roadway intersections. Additionally, or alternatively, routes 106 may include more precise actions or states such as, for example, specific target lanes or precise locations within the lane areas and targeted speed at those positions. In an example, routes 106 include a plurality of precise state sequences along the at least one high level action sequence with a limited lookahead horizon to reach intermediate goals, where the combination of successive iterations of limited horizon state sequences cumulatively correspond to a plurality of trajectories that collectively form the high level route to terminate at the final goal state or region.

Area 108 includes a physical area (e.g., a geographic region) within which vehicles 102 can navigate. In an example, area 108 includes at least one state (e.g., a country, a province, an individual state of a plurality of states included in a country, etc.), at least one portion of a state, at least one city, at least one portion of a city, etc. In some embodiments, area 108 includes at least one named thoroughfare (referred to herein as a “road”) such as a highway, an interstate highway, a parkway, a city street, etc. Additionally, or alternatively, in some examples area 108 includes at least one unnamed road such as a driveway, a section of a parking lot, a section of a vacant and/or undeveloped lot, a dirt path, etc. In some embodiments, a road includes at least one lane (e.g., a portion of the road that can be traversed by vehicles 102). In an example, a road includes at least one lane associated with (e.g., identified based on) at least one lane marking.

Vehicle-to-Infrastructure (V2I) device 110 (sometimes referred to as a Vehicle-to-Infrastructure or Vehicle-to-Everything (V2X) device) includes at least one device configured to be in communication with vehicles 102 and/or V2I infrastructure system 118. In some embodiments, V2I device 110 is configured to be in communication with vehicles 102, remote AV system 114, fleet management system 116, and/or V2I system 118 via network 112. In some embodiments, V2I device 110 includes a radio frequency identification (RFID) device, signage, cameras (e.g., two-dimensional (2D) and/or three-dimensional (3D) cameras), lane markers, streetlights, parking meters, etc. In some embodiments, V2I device 110 is configured to communicate directly with vehicles 102. Additionally, or alternatively, in some embodiments V2I device 110 is configured to communicate with vehicles 102, remote AV system 114, and/or fleet management system 116 via V2I system 118. In some embodiments, V2I device 110 is configured to communicate with V2I system 118 via network 112.

Network 112 includes one or more wired and/or wireless networks. In an example, network 112 includes a cellular network (e.g., a long term evolution (LTE) network, a third generation (3G) network, a fourth generation (4G) network, a fifth generation (5G) network, a code division multiple access (CDMA) network, etc.), a public land mobile network (PLMN), a local area network (LAN), a wide area network (WAN), a metropolitan area network (MAN), a telephone network (e.g., the public switched telephone network (PSTN), a private network, an ad hoc network, an intranet, the Internet, a fiber optic-based network, a cloud computing network, etc., a combination of some or all of these networks, and/or the like.

Remote AV system 114 includes at least one device configured to be in communication with vehicles 102, V2I device 110, network 112, fleet management system 116, and/or V2I system 118 via network 112. In an example, remote AV system 114 includes a server, a group of servers, and/or other like devices. In some embodiments, remote AV system 114 is co-located with the fleet management system 116. In some embodiments, remote AV system 114 is involved in the installation of some or all of the components of a vehicle, including an autonomous system, an autonomous vehicle compute, software implemented by an autonomous vehicle compute, and/or the like. In some embodiments, remote AV system 114 maintains (e.g., updates and/or replaces) such components and/or software during the lifetime of the vehicle.

Fleet management system 116 includes at least one device configured to be in communication with vehicles 102, V2I device 110, remote AV system 114, and/or V2I infrastructure system 118. In an example, fleet management system 116 includes a server, a group of servers, and/or other like devices. In some embodiments, fleet management system 116 is associated with a ridesharing company (e.g., an organization that controls operation of multiple vehicles (e.g., vehicles that include autonomous systems and/or vehicles that do not include autonomous systems) and/or the like).

In some embodiments, V2I system 118 includes at least one device configured to be in communication with vehicles 102, V2I device 110, remote AV system 114, and/or fleet management system 116 via network 112. In some examples, V2I system 118 is configured to be in communication with V2I device 110 via a connection different from network 112. In some embodiments, V2I system 118 includes a server, a group of servers, and/or other like devices. In some embodiments, V2I system 118 is associated with a municipality or a private institution (e.g., a private institution that maintains V2I device 110 and/or the like).

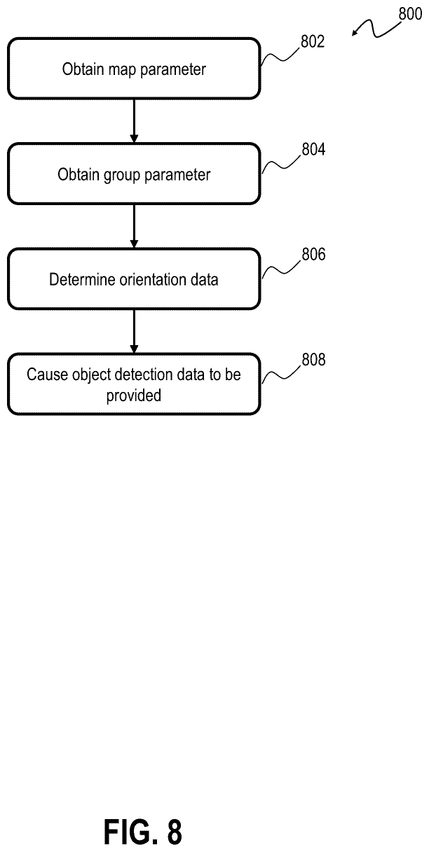

In some embodiments, device 300 is configured to execute software instructions of one or more steps of the disclosed method, as illustrated in FIG. 8.

The number and arrangement of elements illustrated in FIG. 1 are provided as an example. There can be additional elements, fewer elements, different elements, and/or differently arranged elements, than those illustrated in FIG. 1. Additionally, or alternatively, at least one element of environment 100 can perform one or more functions described as being performed by at least one different element of FIG. 1. Additionally, or alternatively, at least one set of elements of environment 100 can perform one or more functions described as being performed by at least one different set of elements of environment 100.

Referring now to FIG. 2, vehicle 200 (which may be the same as, or similar to vehicle 102 of FIG. 1) includes or is associated with autonomous system 202, powertrain control system 204, steering control system 206, and brake system 208. In some embodiments, vehicle 200 is the same as or similar to vehicle 102 (see FIG. 1). In some embodiments, autonomous system 202 is configured to confer vehicle 200 autonomous driving capability (e.g., implement at least one driving automation or maneuver-based function, feature, device, and/or the like that enable vehicle 200 to be partially or fully operated without human intervention including, without limitation, fully autonomous vehicles (e.g., vehicles that forego reliance on human intervention such as Level 5 ADS-operated vehicles), highly autonomous vehicles (e.g., vehicles that forego reliance on human intervention in certain situations such as Level 4 ADS-operated vehicles), conditional autonomous vehicles (e.g., vehicles that forego reliance on human intervention in limited situations such as Level 3 ADS-operated vehicles) and/or the like. In one embodiment, autonomous system 202 includes operational or tactical functionality required to operate vehicle 200 in on-road traffic and perform part or all of Dynamic Driving Task (DDT) on a sustained basis. In another embodiment, autonomous system 202 includes an Advanced Driver Assistance System (ADAS) that includes driver support features. Autonomous system 202 supports various levels of driving automation, ranging from no driving automation (e.g., Level 0) to full driving automation (e.g., Level 5). For a detailed description of fully autonomous vehicles and highly autonomous vehicles, reference may be made to SAE International's standard J3016: Taxonomy and Definitions for Terms Related to On-Road Motor Vehicle Automated Driving Systems, which is incorporated by reference in its entirety. In some embodiments, vehicle 200 is associated with an autonomous fleet manager and/or a ridesharing company.

Autonomous system 202 includes a sensor suite that includes one or more devices such as cameras 202a, LiDAR sensors 202b, radar sensors 202c, and microphones 202d. In some embodiments, autonomous system 202 can include more or fewer devices and/or different devices (e.g., ultrasonic sensors, inertial sensors, GPS receivers (discussed below), odometry sensors that generate data associated with an indication of a distance that vehicle 200 has traveled, and/or the like). In some embodiments, autonomous system 202 uses the one or more devices included in autonomous system 202 to generate data associated with environment 100, described herein. The data generated by the one or more devices of autonomous system 202 can be used by one or more systems described herein to observe the environment (e.g., environment 100) in which vehicle 200 is located. In some embodiments, autonomous system 202 includes communication device 202e, autonomous vehicle compute 202f, drive-by-wire (DBW) system 202h, and safety controller 202g.

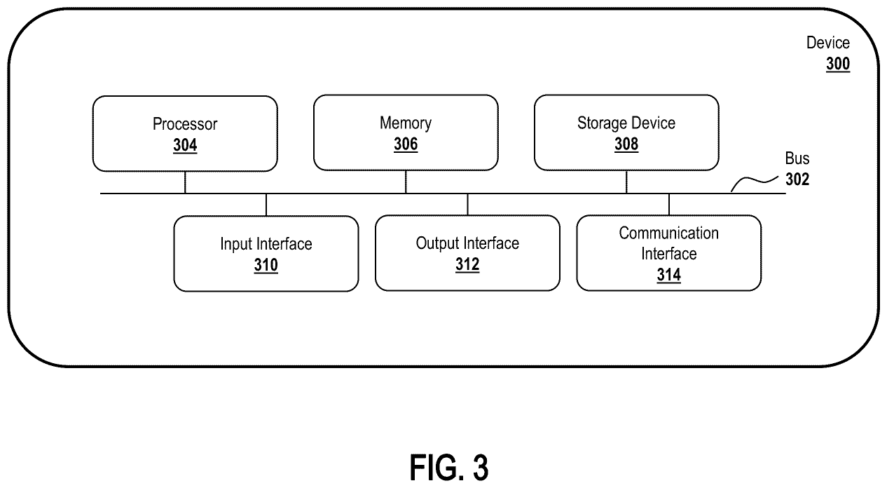

Cameras 202a include at least one device configured to be in communication with communication device 202e, autonomous vehicle compute 202f, and/or safety controller 202g via a bus (e.g., a bus that is the same as or similar to bus 302 of FIG. 3). Cameras 202a include at least one camera (e.g., a digital camera using a light sensor such as a Charge-Coupled Device (CCD), a thermal camera, an infrared (IR) camera, an event camera, and/or the like) to capture images including physical objects (e.g., cars, buses, curbs, people, and/or the like). In some embodiments, camera 202a generates camera data as output. In some examples, camera 202a generates camera data that includes image data associated with an image. In this example, the image data may specify at least one parameter (e.g., image characteristics such as exposure, brightness, etc., an image timestamp, and/or the like) corresponding to the image. In such an example, the image may be in a format (e.g., RAW, JPEG, PNG, and/or the like). In some embodiments, camera 202a includes a plurality of independent cameras configured on (e.g., positioned on) a vehicle to capture images for the purpose of stereopsis (stereo vision). In some examples, camera 202a includes a plurality of cameras that generate image data and transmit the image data to autonomous vehicle compute 202f and/or a fleet management system (e.g., a fleet management system that is the same as or similar to fleet management system 116 of FIG. 1). In such an example, autonomous vehicle compute 202f determines depth to one or more objects in a field of view of at least two cameras of the plurality of cameras based on the image data from the at least two cameras. In some embodiments, cameras 202a is configured to capture images of objects within a distance from cameras 202a (e.g., up to 100 meters, up to a kilometer, and/or the like). Accordingly, cameras 202a include features such as sensors and lenses that are optimized for perceiving objects that are at one or more distances from cameras 202a.

In an embodiment, camera 202a includes at least one camera configured to capture one or more images associated with one or more traffic lights, street signs and/or other physical objects that provide visual navigation information. In some embodiments, camera 202a generates traffic light data associated with one or more images. In some examples, camera 202a generates TLD (Traffic Light Detection) data associated with one or more images that include a format (e.g., RAW, JPEG, PNG, and/or the like). In some embodiments, camera 202a that generates TLD data differs from other systems described herein incorporating cameras in that camera 202a can include one or more cameras with a wide field of view (e.g., a wide-angle lens, a fish-eye lens, a lens having a viewing angle of approximately 120 degrees or more, and/or the like) to generate images about as many physical objects as possible.

Light Detection and Ranging (LiDAR) sensors 202b include at least one device configured to be in communication with communication device 202e, autonomous vehicle compute 202f, and/or safety controller 202g via a bus (e.g., a bus that is the same as or similar to bus 302 of FIG. 3). LiDAR sensors 202b include a system configured to transmit light from a light emitter (e.g., a laser transmitter). Light emitted by LiDAR sensors 202b include light (e.g., infrared light and/or the like) that is outside of the visible spectrum. In some embodiments, during operation, light emitted by LiDAR sensors 202b encounters a physical object (e.g., a vehicle) and is reflected back to LiDAR sensors 202b. In some embodiments, the light emitted by LiDAR sensors 202b does not penetrate the physical objects that the light encounters. LiDAR sensors 202b also include at least one light detector which detects the light that was emitted from the light emitter after the light encounters a physical object. In some embodiments, at least one data processing system associated with LiDAR sensors 202b generates an image (e.g., a point cloud, a combined point cloud, and/or the like) representing the objects included in a field of view of LiDAR sensors 202b. In some examples, the at least one data processing system associated with LiDAR sensor 202b generates an image that represents the boundaries of a physical object, the surfaces (e.g., the topology of the surfaces) of the physical object, and/or the like. In such an example, the image is used to determine the boundaries of physical objects in the field of view of LiDAR sensors 202b.

Radio Detection and Ranging (radar) sensors 202c include at least one device configured to be in communication with communication device 202e, autonomous vehicle compute 202f, and/or safety controller 202g via a bus (e.g., a bus that is the same as or similar to bus 302 of FIG. 3). Radar sensors 202c include a system configured to transmit radio waves (either pulsed or continuously). The radio waves transmitted by radar sensors 202c include radio waves that are within a predetermined spectrum In some embodiments, during operation, radio waves transmitted by radar sensors 202c encounter a physical object and are reflected back to radar sensors 202c. In some embodiments, the radio waves transmitted by radar sensors 202c are not reflected by some objects. In some embodiments, at least one data processing system associated with radar sensors 202c generates signals representing the objects included in a field of view of radar sensors 202c. For example, the at least one data processing system associated with radar sensor 202c generates an image that represents the boundaries of a physical object, the surfaces (e.g., the topology of the surfaces) of the physical object, and/or the like. In some examples, the image is used to determine the boundaries of physical objects in the field of view of radar sensors 202c.

Microphones 202d includes at least one device configured to be in communication with communication device 202e, autonomous vehicle compute 202f, and/or safety controller 202g via a bus (e.g., a bus that is the same as or similar to bus 302 of FIG. 3). Microphones 202d include one or more microphones (e.g., array microphones, external microphones, and/or the like) that capture audio signals and generate data associated with (e.g., representing) the audio signals. In some examples, microphones 202d include transducer devices and/or like devices. In some embodiments, one or more systems described herein can receive the data generated by microphones 202d and determine a position of an object relative to vehicle 200 (e.g., a distance and/or the like) based on the audio signals associated with the data.

Communication device 202e includes at least one device configured to be in communication with cameras 202a, LiDAR sensors 202b, radar sensors 202c, microphones 202d, autonomous vehicle compute 202f, safety controller 202g, and/or DBW (Drive-By-Wire) system 202h. For example, communication device 202e may include a device that is the same as or similar to communication interface 314 of FIG. 3. In some embodiments, communication device 202e includes a vehicle-to-vehicle (V2V) communication device (e.g., a device that enables wireless communication of data between vehicles).

Autonomous vehicle compute 202f include at least one device configured to be in communication with cameras 202a, LiDAR sensors 202b, radar sensors 202c, microphones 202d, communication device 202e, safety controller 202g, and/or DBW system 202h. In some examples, autonomous vehicle compute 202f includes a device such as a client device, a mobile device (e.g., a cellular telephone, a tablet, and/or the like), a server (e.g., a computing device including one or more central processing units, graphical processing units, and/or the like), and/or the like. In some embodiments, autonomous vehicle compute 202f is the same as or similar to autonomous vehicle compute 400, described herein. Additionally, or alternatively, in some embodiments autonomous vehicle compute 202f is configured to be in communication with an autonomous vehicle system (e.g., an autonomous vehicle system that is the same as or similar to remote AV system 114 of FIG. 1), a fleet management system (e.g., a fleet management system that is the same as or similar to fleet management system 116 of FIG. 1), a V2I device (e.g., a V2I device that is the same as or similar to V2I device 110 of FIG. 1), and/or a V2I system (e.g., a V2I system that is the same as or similar to V2I system 118 of FIG. 1).

Safety controller 202g includes at least one device configured to be in communication with cameras 202a, LiDAR sensors 202b, radar sensors 202c, microphones 202d, communication device 202e, autonomous vehicle computer 202f, and/or DBW system 202h. In some examples, safety controller 202g includes one or more controllers (electrical controllers, electromechanical controllers, and/or the like) that are configured to generate and/or transmit control signals to operate one or more devices of vehicle 200 (e.g., powertrain control system 204, steering control system 206, brake system 208, and/or the like). In some embodiments, safety controller 202g is configured to generate control signals that take precedence over (e.g., overrides) control signals generated and/or transmitted by autonomous vehicle compute 202f.

DBW system 202h includes at least one device configured to be in communication with communication device 202e and/or autonomous vehicle compute 202f. In some examples, DBW system 202h includes one or more controllers (e.g., electrical controllers, electromechanical controllers, and/or the like) that are configured to generate and/or transmit control signals to operate one or more devices of vehicle 200 (e.g., powertrain control system 204, steering control system 206, brake system 208, and/or the like). Additionally, or alternatively, the one or more controllers of DBW system 202h are configured to generate and/or transmit control signals to operate at least one different device (e.g., a turn signal, headlights, door locks, windshield wipers, and/or the like) of vehicle 200.

Powertrain control system 204 includes at least one device configured to be in communication with DBW system 202h. In some examples, powertrain control system 204 includes at least one controller, actuator, and/or the like. In some embodiments, powertrain control system 204 receives control signals from DBW system 202h and powertrain control system 204 causes vehicle 200 make longitudinal vehicle motion, such as to start moving forward, stop moving forward, start moving backward, stop moving backward, accelerate in a direction, decelerate in a direction or to make lateral vehicle motion such as performing a left turn, performing a right turn, and/or the like. In an example, powertrain control system 204 causes the energy (e.g., fuel, electricity, and/or the like) provided to a motor of the vehicle to increase, remain the same, or decrease, thereby causing at least one wheel of vehicle 200 to rotate or not rotate. In other words, steering control system 206 causes activities necessary for the regulation of the y-axis component of vehicle motion.

Steering control system 206 includes at least one device configured to rotate one or more wheels of vehicle 200. In some examples, steering control system 206 includes at least one controller, actuator, and/or the like. In some embodiments, steering control system 206 causes the front two wheels and/or the rear two wheels of vehicle 200 to rotate to the left or right to cause vehicle 200 to turn to the left or right.

Brake system 208 includes at least one device configured to actuate one or more brakes to cause vehicle 200 to reduce speed and/or remain stationary. In some examples, brake system 208 includes at least one controller and/or actuator that is configured to cause one or more calipers associated with one or more wheels of vehicle 200 to close on a corresponding rotor of vehicle 200. Additionally, or alternatively, in some examples brake system 208 includes an automatic emergency braking (AEB) system, a regenerative braking system, and/or the like.

In some embodiments, vehicle 200 includes at least one platform sensor (not explicitly illustrated) that measures or infers properties of a state or a condition of vehicle 200. In some examples, vehicle 200 includes platform sensors such as a global positioning system (GPS) receiver, an inertial measurement unit (IMU), a wheel speed sensor, a wheel brake pressure sensor, a wheel torque sensor, an engine torque sensor, a steering angle sensor, and/or the like. Although brake system 208 is illustrated to be located in the near side of vehicle 200 in FIG. 2, brake system 208 may be located anywhere in vehicle 200.

Referring now to FIG. 3, illustrated is a schematic diagram of a device 300. As illustrated, device 300 includes processor 304, memory 306, storage device 308, input interface 310, output interface 312, communication interface 314, and bus 302. In some embodiments, device 300 corresponds to at least one device of vehicles 102 (e.g., at least one device of a system of vehicles 102), at least one device of remote AV system 114, fleet management system 116, V2I system 118, and/or one or more devices of network 112 (e.g., one or more devices of a system of network 112). In some embodiments, one or more devices of vehicles 102 (e.g., one or more devices of a system of vehicles 102 such as at least one device of remote AV system 114, fleet management system 116, and V2I system 118, and/or one or more devices of network 112 (e.g., one or more devices of a system of network 112) include at least one device 300 and/or at least one component of device 300. As shown in FIG. 3, device 300 includes bus 302, processor 304, memory 306, storage device 308, input interface 310, output interface 312, and communication interface 314.

Bus 302 includes a component that permits communication among the components of device 300. In some cases, processor 304 includes a processor (e.g., a central processing unit (CPU), a graphics processing unit (GPU), an accelerated processing unit (APU), and/or the like), a microphone, a digital signal processor (DSP), and/or any processing component (e.g., a field-programmable gate array (FPGA), an application specific integrated circuit (ASIC), and/or the like) that can be programmed to perform at least one function. Memory 306 includes random access memory (RAM), read-only memory (ROM), and/or another type of dynamic and/or static storage device (e.g., flash memory, magnetic memory, optical memory, and/or the like) that stores data and/or instructions for use by processor 304.

Storage device 308 stores data and/or software related to the operation and use of device 300. In some examples, storage device 308 includes a hard disk (e.g., a magnetic disk, an optical disk, a magneto-optic disk, a solid state disk, and/or the like), a compact disc (CD), a digital versatile disc (DVD), a floppy disk, a cartridge, a magnetic tape, a CD-ROM, RAM, PROM, EPROM, FLASH-EPROM, NV-RAM, and/or another type of computer readable medium, along with a corresponding drive.

Input interface 310 includes a component that permits device 300 to receive information, such as via user input (e.g., a touchscreen display, a keyboard, a keypad, a mouse, a button, a switch, a microphone, a camera, and/or the like). Additionally or alternatively, in some embodiments input interface 310 includes a sensor that senses information (e.g., a global positioning system (GPS) receiver, an accelerometer, a gyroscope, an actuator, and/or the like). Output interface 312 includes a component that provides output information from device 300 (e.g., a display, a speaker, one or more light-emitting diodes (LEDs), and/or the like).

In some embodiments, communication interface 314 includes a transceiver-like component (e.g., a transceiver, a separate receiver and transmitter, and/or the like) that permits device 300 to communicate with other devices via a wired connection, a wireless connection, or a combination of wired and wireless connections. In some examples, communication interface 314 permits device 300 to receive information from another device and/or provide information to another device. In some examples, communication interface 314 includes an Ethernet interface, an optical interface, a coaxial interface, an infrared interface, a radio frequency (RF) interface, a universal serial bus (USB) interface, a Wi-Fi© interface, a cellular network interface, and/or the like.

In some embodiments, device 300 performs one or more processes described herein. Device 300 performs these processes based on processor 304 executing software instructions stored by a computer-readable medium, such as memory 306 and/or storage device 308. A computer-readable medium (e.g., a non-transitory computer readable medium) is defined herein as a non-transitory memory device. A non-transitory memory device includes memory space located inside a single physical storage device or memory space spread across multiple physical storage devices.

In some embodiments, software instructions are read into memory 306 and/or storage device 308 from another computer-readable medium or from another device via communication interface 314. When executed, software instructions stored in memory 306 and/or storage device 308 cause processor 304 to perform one or more processes described herein. Additionally or alternatively, hardwired circuitry is used in place of or in combination with software instructions to perform one or more processes described herein. Thus, embodiments described herein are not limited to any specific combination of hardware circuitry and software unless explicitly stated otherwise.

Memory 306 and/or storage device 308 includes data storage or at least one data structure (e.g., a database and/or the like). Device 300 is capable of receiving information from, storing information in, communicating information to, or searching information stored in the data storage or the at least one data structure in memory 306 or storage device 308. In some examples, the information includes network data, input data, output data, or any combination thereof.

In some embodiments, device 300 is configured to execute software instructions that are either stored in memory 306 and/or in the memory of another device (e.g., another device that is the same as or similar to device 300). As used herein, the term “module” refers to at least one instruction stored in memory 306 and/or in the memory of another device that, when executed by processor 304 and/or by a processor of another device (e.g., another device that is the same as or similar to device 300) cause device 300 (e.g., at least one component of device 300) to perform one or more processes described herein. In some embodiments, a module is implemented in software, firmware, hardware, and/or the like.

The number and arrangement of components illustrated in FIG. 3 are provided as an example. In some embodiments, device 300 can include additional components, fewer components, different components, or differently arranged components than those illustrated in FIG. 3. Additionally or alternatively, a set of components (e.g., one or more components) of device 300 can perform one or more functions described as being performed by another component or another set of components of device 300.

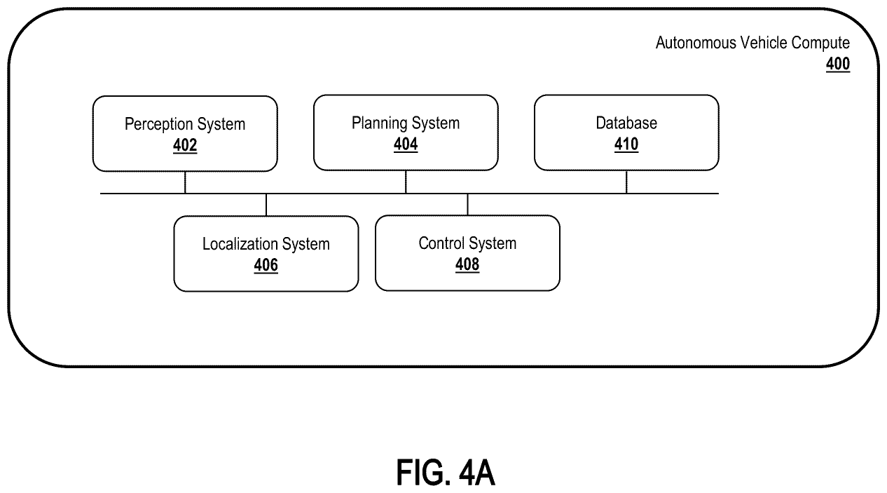

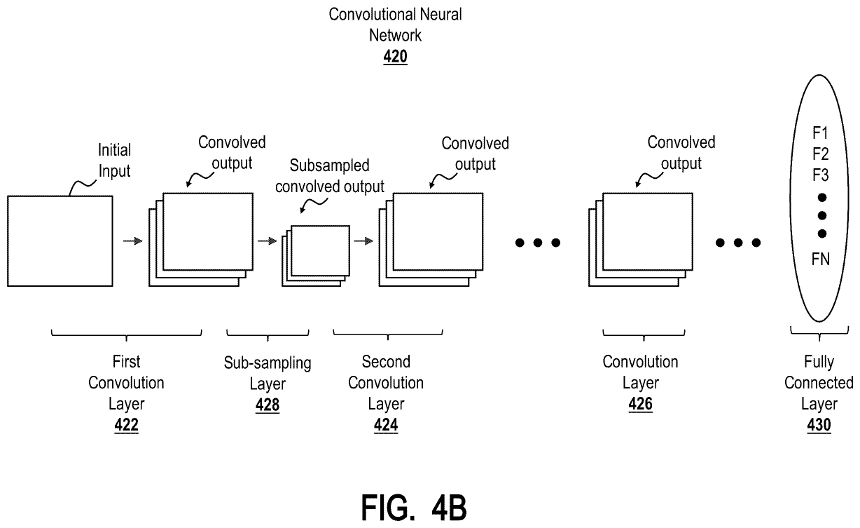

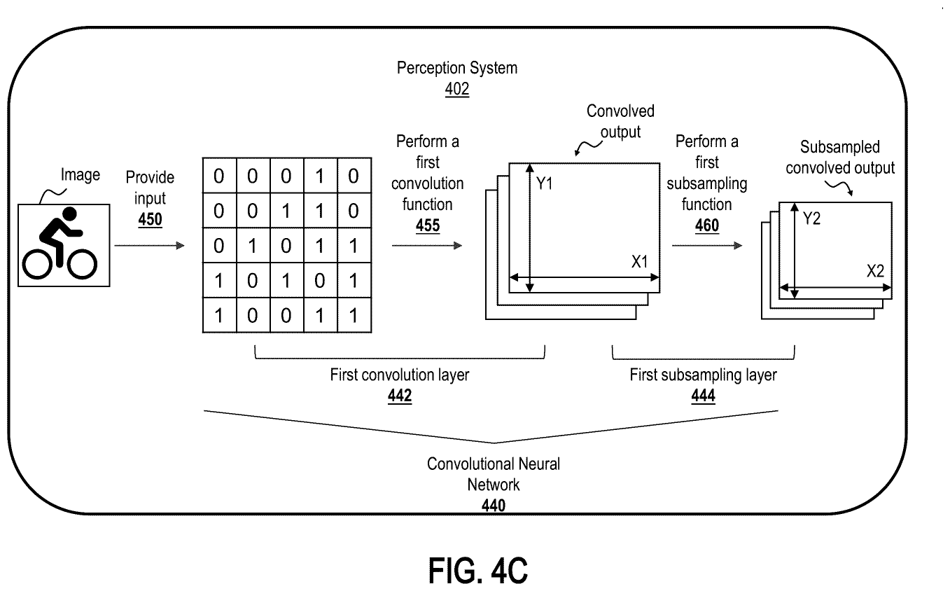

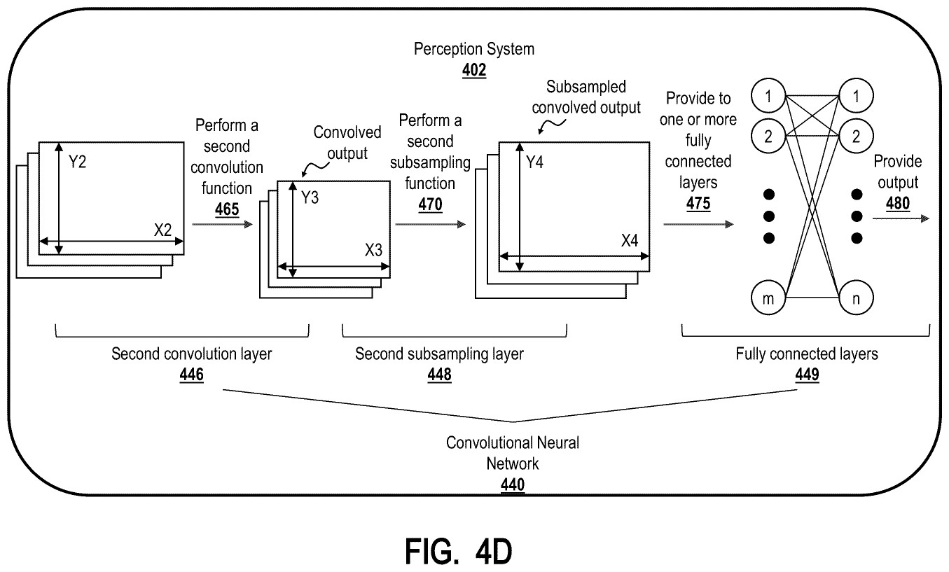

Referring now to FIG. 4, illustrated is an example block diagram of an autonomous vehicle compute 400 (sometimes referred to as an “AV stack”). As illustrated, autonomous vehicle compute 400 includes perception system 402 (sometimes referred to as a perception module), planning system 404 (sometimes referred to as a planning module), localization system 406 (sometimes referred to as a localization module), control system 408 (sometimes referred to as a control module), and database 410. In some embodiments, perception system 402, planning system 404, localization system 406, control system 408, and database 410 are included and/or implemented in an autonomous navigation system of a vehicle (e.g., autonomous vehicle compute 202f of vehicle 200). Additionally, or alternatively, in some embodiments perception system 402, planning system 404, localization system 406, control system 408, and database 410 are included in one or more standalone systems (e.g., one or more systems that are the same as or similar to autonomous vehicle compute 400 and/or the like). In some examples, perception system 402, planning system 404, localization system 406, control system 408, and database 410 are included in one or more standalone systems that are located in a vehicle and/or at least one remote system as described herein. In some embodiments, any and/or all of the systems included in autonomous vehicle compute 400 are implemented in software (e.g., in software instructions stored in memory), computer hardware (e.g., by microprocessors, microcontrollers, application-specific integrated circuits (ASICs), Field Programmable Gate Arrays (FPGAs), and/or the like), or combinations of computer software and computer hardware. It will also be understood that, in some embodiments, autonomous vehicle compute 400 is configured to be in communication with a remote system (e.g., an autonomous vehicle system that is the same as or similar to remote AV system 114, a fleet management system 116 that is the same as or similar to fleet management system 116, a V2I system that is the same as or similar to V2I system 118, and/or the like).

In some embodiments, perception system 402 receives data associated with at least one physical object (e.g., data that is used by perception system 402 to detect the at least one physical object) in an environment and classifies the at least one physical object. In some examples, perception system 402 receives image data captured by at least one camera (e.g., cameras 202a), the image associated with (e.g., representing) one or more physical objects within a field of view of the at least one camera. In such an example, perception system 402 classifies at least one physical object based on one or more groupings of physical objects (e.g., bicycles, vehicles, traffic signs, pedestrians, and/or the like). In some embodiments, perception system 402 transmits data associated with the classification of the physical objects to planning system 404 based on perception system 402 classifying the physical objects.

In some embodiments, planning system 404 receives data associated with a destination and generates data associated with at least one route (e.g., routes 106) along which a vehicle (e.g., vehicles 102) can travel along toward a destination. In some embodiments, planning system 404 periodically or continuously receives data from perception system 402 (e.g., data associated with the classification of physical objects, described above) and planning system 404 updates the at least one trajectory or generates at least one different trajectory based on the data generated by perception system 402. In other words, planning system 404 may perform tactical function-related tasks that are required to operate vehicle 102 in on-road traffic. Tactical efforts involve maneuvering the vehicle in traffic during a trip, including but not limited to deciding whether and when to overtake another vehicle, change lanes, or selecting an appropriate speed, acceleration, deacceleration, etc. In some embodiments, planning system 404 receives data associated with an updated position of a vehicle (e.g., vehicles 102) from localization system 406 and planning system 404 updates the at least one trajectory or generates at least one different trajectory based on the data generated by localization system 406.

In some embodiments, localization system 406 receives data associated with (e.g., representing) a location of a vehicle (e.g., vehicles 102) in an area. In some examples, localization system 406 receives LiDAR data associated with at least one point cloud generated by at least one LiDAR sensor (e.g., LiDAR sensors 202b). In certain examples, localization system 406 receives data associated with at least one point cloud from multiple LiDAR sensors and localization system 406 generates a combined point cloud based on each of the point clouds. In these examples, localization system 406 compares the at least one point cloud or the combined point cloud to two-dimensional (2D) and/or a three-dimensional (3D) map of the area stored in database 410. Localization system 406 then determines the position of the vehicle in the area based on localization system 406 comparing the at least one point cloud or the combined point cloud to the map. In some embodiments, the map includes a combined point cloud of the area generated prior to navigation of the vehicle. In some embodiments, maps include, without limitation, high-precision maps of the roadway geometric properties, maps describing road network connectivity properties, maps describing roadway physical properties (such as traffic speed, traffic volume, the number of vehicular and cyclist traffic lanes, lane width, lane traffic directions, or lane marker types and locations, or combinations thereof), and maps describing the spatial locations of road features such as crosswalks, traffic signs or other travel signals of various types. In some embodiments, the map is generated in real-time based on the data received by the perception system.

In another example, localization system 406 receives Global Navigation Satellite System (GNSS) data generated by a global positioning system (GPS) receiver. In some examples, localization system 406 receives GNSS data associated with the location of the vehicle in the area and localization system 406 determines a latitude and longitude of the vehicle in the area. In such an example, localization system 406 determines the position of the vehicle in the area based on the latitude and longitude of the vehicle. In some embodiments, localization system 406 generates data associated with the position of the vehicle. In some examples, localization system 406 generates data associated with the position of the vehicle based on localization system 406 determining the position of the vehicle. In such an example, the data associated with the position of the vehicle includes data associated with one or more semantic properties corresponding to the position of the vehicle.

In some embodiments, control system 408 receives data associated with at least one trajectory from planning system 404 and control system 408 controls operation of the vehicle. In some examples, control system 408 receives data associated with at least one trajectory from planning system 404 and control system 408 controls operation of the vehicle by generating and transmitting control signals to cause a powertrain control system (e.g., DBW system 202h, powertrain control system 204, and/or the like), a steering control system (e.g., steering control system 206), and/or a brake system (e.g., brake system 208) to operate. For example, control system 408 is configured to perform operational functions such as a lateral vehicle motion control or a longitudinal vehicle motion control. The lateral vehicle motion control causes activities necessary for the regulation of the y-axis component of vehicle motion. The longitudinal vehicle motion control causes activities necessary for the regulation of the x-axis component of vehicle motion. In an example, where a trajectory includes a left turn, control system 408 transmits a control signal to cause steering control system 206 to adjust a steering angle of vehicle 200, thereby causing vehicle 200 to turn left. Additionally, or alternatively, control system 408 generates and transmits control signals to cause other devices (e.g., headlights, turn signal, door locks, windshield wipers, and/or the like) of vehicle 200 to change states.

In some embodiments, perception system 402, planning system 404, localization system 406, and/or control system 408 implement at least one machine learning model (e.g., at least one multilayer perceptron (MLP), at least one convolutional neural network (CNN), at least one recurrent neural network (RNN), at least one autoencoder, at least one transformer, and/or the like). In some examples, perception system 402, planning system 404, localization system 406, and/or control system 408 implement at least one machine learning model alone or in combination with one or more of the above-noted systems. In some examples, perception system 402, planning system 404, localization system 406, and/or control system 408 implement at least one machine learning model as part of a pipeline (e.g., a pipeline for identifying one or more objects located in an environment and/or the like). An example of an implementation of a machine learning model is included below with respect to FIGS. 4B-4D.

Database 410 stores data that is transmitted to, received from, and/or updated by perception system 402, planning system 404, localization system 406 and/or control system 408. In some examples, database 410 includes a storage component (e.g., a storage component that is the same as or similar to storage device 308 of FIG. 3) that stores data and/or software related to the operation and uses at least one system of autonomous vehicle compute 400. In some embodiments, database 410 stores data associated with 2D and/or 3D maps of at least one area. In some examples, database 410 stores data associated with 2D and/or 3D maps of a portion of a city, multiple portions of multiple cities, multiple cities, a county, a state, a State (e.g., a country), and/or the like). In such an example, a vehicle (e.g., a vehicle that is the same as or similar to vehicles 102 and/or vehicle 200) can drive along one or more drivable regions (e.g., single-lane roads, multi-lane roads, highways, back roads, off road trails, and/or the like) and cause at least one LiDAR sensor (e.g., a LiDAR sensor that is the same as or similar to LiDAR sensors 202b) to generate data associated with an image representing the objects included in a field of view of the at least one LiDAR sensor.

In some embodiments, database 410 can be implemented across a plurality of devices. In some examples, database 410 is included in a vehicle (e.g., a vehicle that is the same as or similar to vehicles 102 and/or vehicle 200), an autonomous vehicle system (e.g., an autonomous vehicle system that is the same as or similar to remote AV system 114, a fleet management system (e.g., a fleet management system that is the same as or similar to fleet management system 116 of FIG. 1, a V2I system (e.g., a V2I system that is the same as or similar to V2I system 118 of FIG. 1) and/or the like.

Referring now to FIG. 4B, illustrated is a diagram of an implementation of a machine learning model. More specifically, illustrated is a diagram of an implementation of a convolutional neural network (CNN) 420. For purposes of illustration, the following description of CNN 420 will be with respect to an implementation of CNN 420 by perception system 402. However, it will be understood that in some examples CNN 420 (e.g., one or more components of CNN 420) is implemented by other systems different from, or in addition to, perception system 402 such as planning system 404, localization system 406, and/or control system 408. While CNN 420 includes certain features as described herein, these features are provided for the purpose of illustration and are not intended to limit the present disclosure.

CNN 420 includes a plurality of convolution layers including first convolution layer 422, second convolution layer 424, and convolution layer 426. In some embodiments, CNN 420 includes sub-sampling layer 428 (sometimes referred to as a pooling layer). In some embodiments, sub-sampling layer 428 and/or other subsampling layers have a dimension (i.e., an amount of nodes) that is less than a dimension of an upstream system. By virtue of sub-sampling layer 428 having a dimension that is less than a dimension of an upstream layer, CNN 420 consolidates the amount of data associated with the initial input and/or the output of an upstream layer to thereby decrease the amount of computations necessary for CNN 420 to perform downstream convolution operations. Additionally, or alternatively, by virtue of sub-sampling layer 428 being associated with (e.g., configured to perform) at least one subsampling function (as described below with respect to FIGS. 4C and 4D), CNN 420 consolidates the amount of data associated with the initial input.

Perception system 402 performs convolution operations based on perception system 402 providing respective inputs and/or outputs associated with each of first convolution layer 422, second convolution layer 424, and convolution layer 426 to generate respective outputs. In some examples, perception system 402 implements CNN 420 based on perception system 402 providing data as input to first convolution layer 422, second convolution layer 424, and convolution layer 426. In such an example, perception system 402 provides the data as input to first convolution layer 422, second convolution layer 424, and convolution layer 426 based on perception system 402 receiving data from one or more different systems (e.g., one or more systems of a vehicle that is the same as or similar to vehicle 102), a remote AV system that is the same as or similar to remote AV system 114, a fleet management system that is the same as or similar to fleet management system 116, a V2I system that is the same as or similar to V2I system 118, and/or the like). A detailed description of convolution operations is included below with respect to FIG. 4C.

In some embodiments, perception system 402 provides data associated with an input (referred to as an initial input) to first convolution layer 422 and perception system 402 generates data associated with an output using first convolution layer 422. In some embodiments, perception system 402 provides an output generated by a convolution layer as input to a different convolution layer. For example, perception system 402 provides the output of first convolution layer 422 as input to sub-sampling layer 428, second convolution layer 424, and/or convolution layer 426. In such an example, first convolution layer 422 is referred to as an upstream layer and sub-sampling layer 428, second convolution layer 424, and/or convolution layer 426 are referred to as downstream layers. Similarly, in some embodiments perception system 402 provides the output of sub-sampling layer 428 to second convolution layer 424 and/or convolution layer 426 and, in this example, sub-sampling layer 428 would be referred to as an upstream layer and second convolution layer 424 and/or convolution layer 426 would be referred to as downstream layers.

In some embodiments, perception system 402 processes the data associated with the input provided to CNN 420 before perception system 402 provides the input to CNN 420. For example, perception system 402 processes the data associated with the input provided to CNN 420 based on perception system 402 normalizing sensor data (e.g., image data, LiDAR data, radar data, and/or the like).

In some embodiments, CNN 420 generates an output based on perception system 402 performing convolution operations associated with each convolution layer. In some examples, CNN 420 generates an output based on perception system 402 performing convolution operations associated with each convolution layer and an initial input. In some embodiments, perception system 402 generates the output and provides the output as fully connected layer 430. In some examples, perception system 402 provides the output of convolution layer 426 as fully connected layer 430, where fully connected layer 430 includes data associated with a plurality of feature values referred to as F1, F2 . . . FN. In this example, the output of convolution layer 426 includes data associated with a plurality of output feature values that represent a prediction.

In some embodiments, perception system 402 identifies a prediction from among a plurality of predictions based on perception system 402 identifying a feature value that is associated with the highest likelihood of being the correct prediction from among the plurality of predictions. For example, where fully connected layer 430 includes feature values F1, F2, . . . FN, and F1 is the greatest feature value, perception system 402 identifies the prediction associated with F1 as being the correct prediction from among the plurality of predictions. In some embodiments, perception system 402 trains CNN 420 to generate the prediction. In some examples, perception system 402 trains CNN 420 to generate the prediction based on perception system 402 providing training data associated with the prediction to CNN 420.

Referring now to FIGS. 4C and 4D, illustrated is a diagram of example operation of CNN 440 by perception system 402. In some embodiments, CNN 440 (e.g., one or more components of CNN 440) is the same as, or similar to, CNN 420 (e.g., one or more components of CNN 420) (see FIG. 4B).

At step 450, perception system 402 provides data associated with an image as input to CNN 440 (step 450). For example, as illustrated, perception system 402 provides the data associated with the image to CNN 440, where the image is a greyscale image represented as values stored in a two-dimensional (2D) array. In some embodiments, the data associated with the image may include data associated with a color image, the color image represented as values stored in a three-dimensional (3D) array. Additionally, or alternatively, the data associated with the image may include data associated with an infrared image, a radar image, and/or the like.

At step 455, CNN 440 performs a first convolution function. For example, CNN 440 performs the first convolution function based on CNN 440 providing the values representing the image as input to one or more neurons (not explicitly illustrated) included in first convolution layer 442. In this example, the values representing the image can correspond to values representing a region of the image (sometimes referred to as a receptive field). In some embodiments, each neuron is associated with a filter (not explicitly illustrated). A filter (sometimes referred to as a kernel) is representable as an array of values that corresponds in size to the values provided as input to the neuron. In one example, a filter may be configured to identify edges (e.g., horizontal lines, vertical lines, straight lines, and/or the like). In successive convolution layers, the filters associated with neurons may be configured to identify successively more complex patterns (e.g., arcs, objects, and/or the like).

In some embodiments, CNN 440 performs the first convolution function based on CNN 440 multiplying the values provided as input to each of the one or more neurons included in first convolution layer 442 with the values of the filter that corresponds to each of the one or more neurons. For example, CNN 440 can multiply the values provided as input to each of the one or more neurons included in first convolution layer 442 with the values of the filter that corresponds to each of the one or more neurons to generate a single value or an array of values as an output. In some embodiments, the collective output of the neurons of first convolution layer 442 is referred to as a convolved output. In some embodiments, where each neuron has the same filter, the convolved output is referred to as a feature map.

In some embodiments, CNN 440 provides the outputs of each neuron of first convolutional layer 442 to neurons of a downstream layer. For purposes of clarity, an upstream layer can be a layer that transmits data to a different layer (referred to as a downstream layer). For example, CNN 440 can provide the outputs of each neuron of first convolutional layer 442 to corresponding neurons of a subsampling layer. In an example, CNN 440 provides the outputs of each neuron of first convolutional layer 442 to corresponding neurons of first subsampling layer 444. In some embodiments, CNN 440 adds a bias value to the aggregates of all the values provided to each neuron of the downstream layer. For example, CNN 440 adds a bias value to the aggregates of all the values provided to each neuron of first subsampling layer 444. In such an example, CNN 440 determines a final value to provide to each neuron of first subsampling layer 444 based on the aggregates of all the values provided to each neuron and an activation function associated with each neuron of first subsampling layer 444.

At step 460, CNN 440 performs a first subsampling function. For example, CNN 440 can perform a first subsampling function based on CNN 440 providing the values output by first convolution layer 442 to corresponding neurons of first subsampling layer 444. In some embodiments, CNN 440 performs the first subsampling function based on an aggregation function. In an example, CNN 440 performs the first subsampling function based on CNN 440 determining the maximum input among the values provided to a given neuron (referred to as a max pooling function). In another example, CNN 440 performs the first subsampling function based on CNN 440 determining the average input among the values provided to a given neuron (referred to as an average pooling function). In some embodiments, CNN 440 generates an output based on CNN 440 providing the values to each neuron of first subsampling layer 444, the output sometimes referred to as a subsampled convolved output.

At step 465, CNN 440 performs a second convolution function. In some embodiments, CNN 440 performs the second convolution function in a manner similar to how CNN 440 performed the first convolution function, described above. In some embodiments, CNN 440 performs the second convolution function based on CNN 440 providing the values output by first subsampling layer 444 as input to one or more neurons (not explicitly illustrated) included in second convolution layer 446. In some embodiments, each neuron of second convolution layer 446 is associated with a filter, as described above. The filter(s) associated with second convolution layer 446 may be configured to identify more complex patterns than the filter associated with first convolution layer 442, as described above.

In some embodiments, CNN 440 performs the second convolution function based on CNN 440 multiplying the values provided as input to each of the one or more neurons included in second convolution layer 446 with the values of the filter that corresponds to each of the one or more neurons. For example, CNN 440 can multiply the values provided as input to each of the one or more neurons included in second convolution layer 446 with the values of the filter that corresponds to each of the one or more neurons to generate a single value or an array of values as an output.

In some embodiments, CNN 440 provides the outputs of each neuron of second convolutional layer 446 to neurons of a downstream layer. For example, CNN 440 can provide the outputs of each neuron of first convolutional layer 442 to corresponding neurons of a subsampling layer. In an example, CNN 440 provides the outputs of each neuron of first convolutional layer 442 to corresponding neurons of second subsampling layer 448. In some embodiments, CNN 440 adds a bias value to the aggregates of all the values provided to each neuron of the downstream layer. For example, CNN 440 adds a bias value to the aggregates of all the values provided to each neuron of second subsampling layer 448. In such an example, CNN 440 determines a final value to provide to each neuron of second subsampling layer 448 based on the aggregates of all the values provided to each neuron and an activation function associated with each neuron of second subsampling layer 448.

At step 470, CNN 440 performs a second subsampling function. For example, CNN 440 can perform a second subsampling function based on CNN 440 providing the values output by second convolution layer 446 to corresponding neurons of second subsampling layer 448. In some embodiments, CNN 440 performs the second subsampling function based on CNN 440 using an aggregation function. In an example, CNN 440 performs the first subsampling function based on CNN 440 determining the maximum input or an average input among the values provided to a given neuron, as described above. In some embodiments, CNN 440 generates an output based on CNN 440 providing the values to each neuron of second subsampling layer 448.

At step 475, CNN 440 provides the output of each neuron of second subsampling layer 448 to fully connected layers 449. For example, CNN 440 provides the output of each neuron of second subsampling layer 448 to fully connected layers 449 to cause fully connected layers 449 to generate an output 480. In some embodiments, fully connected layers 449 are configured to generate an output 480 associated with a prediction (sometimes referred to as a classification). The prediction may include an indication that an object included in the image provided as input to CNN 440 includes an object, a set of objects, and/or the like. In some embodiments, perception system 402 performs one or more operations and/or provides the data associated with the prediction to a different system, described herein.

The present disclosure relates to systems, methods, and computer program products that provide for the determination of orientation of objects (e.g., static objects, dynamic objects, agents, vehicles) by an autonomous vehicle. In particular, the present disclosure can be used for offline purposes, such as for training of machine-learning models and/or neural networks, and/or online purposes, such as for use by an autonomous vehicle in real-time object detection and navigation. The disclosed systems, methods, and computer program products can be integrated at many different points in the labelling pipeline of an autonomous vehicle.

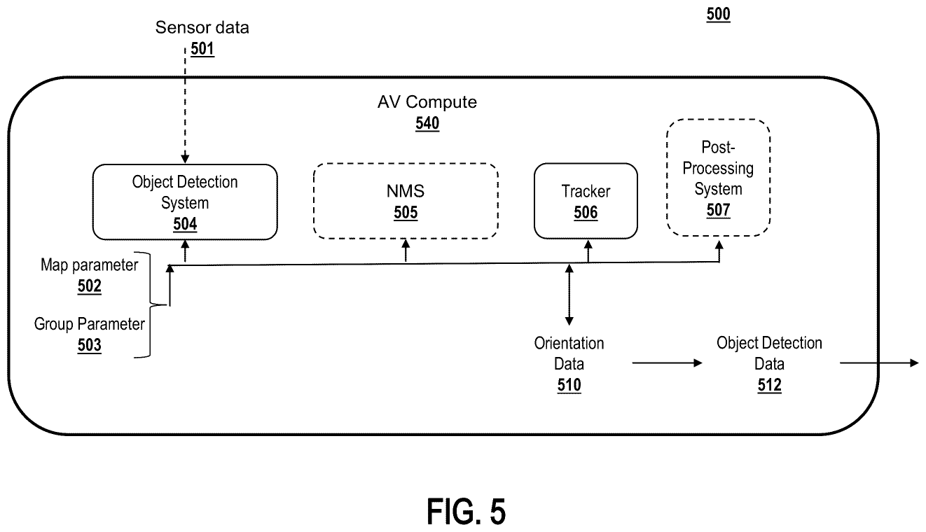

Referring now to FIG. 5, illustrated is a diagram of a system 500 for object orientation determination. In some embodiments, system 500 is connected with and/or incorporated in a vehicle (e.g., an autonomous vehicle that is the same as, or similar to, vehicle 102 of FIG. 2 or vehicle 200 of FIG. 2). In one or more embodiments or examples, system 500 is in communication with and/or a part of an AV (e.g., such as Autonomous System 202 illustrated in FIG. 2, device 300 of FIG. 3), an AV system, an AV compute 540 (such as AV compute 202f of FIG. 2 and/or AV compute 400 of FIG. 4), a remote AV system (such as remote AV system 114 of FIG. 1), a fleet management system (such as fleet management system 116 of FIG. 1), and a V2I system (such as V2I system 118 of FIG. 1). The system 500 can be for operating an autonomous vehicle. The system 500 may not be for operating an autonomous vehicle.

In one or more embodiments or examples, the system 500 includes one or more of: a device (such as device 300 of FIG. 3), a localization system (such as localization system 406 of FIG. 4), a planning system (such as the planning system 404 of FIG. 4), a perception system (such as the perception system 402 of FIG. 4), and a control system (such as the control system 408 of FIG. 4).

Disclosed herein is a system 500. The system 500 includes at least one processor. The system 500 includes at least one memory storing instructions thereon that, when executed by the at least one processor, cause the at least one processor to perform operations including obtaining a map parameter 502 indicative of a predetermined position of a first object in an environment where an autonomous vehicle is configured to operate. The operations include obtaining a group parameter 503 indicative of a predetermined relation between objects of a group, wherein the environment comprises the objects. The operations include determining based on the map parameter 502 and the group parameter 503, orientation data 510 indicative of an orientation of at least one object amongst the first object and the objects. The operations include causing object detection data 512 associated with the at least one object to be provided to a device based on the orientation data 510, wherein the object detection data is indicative of detection of one or more spatial features of the at least one object.

In one or more examples or embodiments, the system 500 includes an object detection system 504, a tracker 506, and optionally a non-maximum suppression scheme (NMS) 505, and optionally a post-processing system 507.

In one or more examples or embodiments, the system 500 is configured to use the map parameter(s) 502 and group parameter(s) 503 for determining objects and/or object interactions in the environment, such as via object detection system 504. For example, the system 500 uses the map parameter(s) 502 and group parameter(s) 503 as additional cues to correct object detections in terms of position, orientation, and size of objects. Group parameters and map parameters can be obtained from heuristics and/or data analysis. The use of the map parameter(s) 502 and group parameter(s) 503 can be advantageous in situations with sensor data 501 having sparse point clouds, as the system 500 can supplement the point clouds for determining object orientations. The system 500 may be used offline, such as for training of machine-learning models for improved identification and labeling in the environment, as well as online for operation of an autonomous vehicle.

Advantageously, the disclosed system 500, in some examples, is particularly useful for monocular vision approaches that have high uncertainty in the depth dimensions. The system 500 can be used on an autonomous vehicle (e.g., online), such as for increasing detection performances, such as via object detection system 504, and/or tracking purposes, such as via tracker 506. The system 500 can be used offline for perception and/or auto-labeling, which could noticeably increase detection performance, such as for auto-labeling and/or semi-supervised learning, such as for improving labeling quality.

In one or more examples or embodiments, the system 500 utilizes the map parameter 502 and/or group parameter 503 for different operations of the AV compute 540 as shown in FIG. 5. For example, the system 500 utilizes the map parameter 502 and/or group parameter 503 at one or more of the object detection system 504, the non-maximum suppression scheme (NMS) 505, the tracker 506, and the post-processing system 507.

In one or more examples or embodiments, the system 500 is configured to obtain and use a map parameter 502 (e.g., map prior). The system 500, for example, obtains the map parameter 502 from memory or storage devices (such as memory 306 and storage device 308 of FIG. 3) and/or from a database (such as database 410 of FIG. 4). The map parameter 502 can be stored locally on the AV and/or may be stored on a distributed network, such as a cloud network.

In one or more examples or embodiments, the map parameter 502 is indicative of a predetermined position of a first object in the environment. In other words, the map parameter 502, in some examples, provides for positioning information about the first object in the environment. The map parameter 502 can be indicative of an assumption about the likely position and orientation of an object in a particular region, such as the size and orientation of objects in a parking lot. Map parameters can be determined as representative of rectangular vehicles, but can be adjusted to other polygons, such as more advanced polygons.

In one or more examples or embodiments, the environment includes one or more objects including the first object, and optionally a second objects. In one or more examples or embodiments, the second objects are different than the first object. The second objects, in some examples, are known as objects in a group. The term second objects and objects in a group can be used interchangeably herein. In one or more examples or embodiments, the first object is an object that has a particular positioning in the environment. For example, the first object may be a feature of the environment that may typically lead to a position of another object with respect to the first object. Example first objects include agents, vehicles, pedestrians, parking lots, sides of roads, stop signs, and stop lights. A parking lot, in some examples, includes a number of parking spaces for parking of vehicles. If the vehicle is properly parked, it would have a position within the parking spot with either the front end or the back end facing outwards. Similarly, a vehicle parked on the side of the road may have particular positioning where the vehicle is generally aligned (e.g., parallel) with the flow of traffic. The map parameter 502 may be indicative of such a predetermined position (e.g., predetermined orientation). The map parameter 502, in some examples, includes predetermined position for a number of different first objects. The predetermined position as indicated by the map parameter 502, in some examples, includes one or more of size, orientation, alignment, lateral alignment, longitudinal alignment, etc.

The environment is an environment where the autonomous vehicle is configured to operate. Therefore, the environment may be larger than the particular area that the autonomous vehicle is operating in, and may extend beyond any sensor capabilities of the autonomous vehicle. In one or more examples or embodiments, the environment is a particular region, and the map parameter 502 is indicative of how objects are likely to be positioning in the particular region. The system 500, for example, filters out areas where the autonomous vehicle is not configured to operate in, such as an offroad area.

In one or more examples or embodiments, the system 500 is configured to obtain and use a group parameter 503 (e.g., group prior). The system 500, for example, obtains the group parameter 503 from memory or storage devices (such as memory 306 and storage device 308 of FIG. 3) and/or from a database (such as database 410 of FIG. 4). The group parameter 503 can be stored locally on the AV and/or may be stored on a distributed network, such as a cloud network. Group parameters may be obtained implicitly by a data-driven approach, or may be obtained from an explicit group assignment. For example, an explicit group assignment means that objects are marked as grouped together from a set of heuristics, or some geometrical algorithms. For instance, pedestrians are clustered together, and marked as belonging to the same group, by classical clustering algorithms that would be deployed on their position. Then, an attribute that indicates that those pedestrians are part of the same group/cluster are be fed to a neural network, on top of the other attributes of those pedestrians, to help refine their detections in some examples. As another example, a data-driven approach means that the neural network, instead of receiving inputs in which objects are explicitly marked as being part of the same group, instead receives inputs that can help it discover group objects on its own. For example, the system 500 is configured to compute pair-wise distances between all the pedestrians, or cars. When using those pair-wise distances as additional input to the network, it can implicitly use them to discover object groups on its own, without needing us to explicitly create the groups.

In one or more examples or embodiments, the group parameter 503 is indicative of a predetermined relation (e.g., relationship) between objects of a group (e.g., second objects, a group of objects, a group of agents, a group of pedestrians, a group of vehicles). For example, group parameters are indicative of assumptions about the interaction (e.g., relationship) of a group of objects, such as cars parked back to back along a road. The second objects (e.g., objects of the group) can be parked vehicles (e.g., parked in a parking lot, roadside, driveway), and the group can be a group of parked vehicles. In certain examples, an orientation of the vehicles (such as the group) parked along the same road or in the same parking lot are correlated by the group parameter 503 (e.g., the vehicles face the same direction, the vehicles face one of two directions, etc.). Similarly, stopped vehicles (e.g., due to a traffic light, traffic jam) can have correlations indicative by the group parameter 503. For example, in a traffic jam all vehicles stay in their respective lanes and have the same orientation. The system 500 can use the group parameter 503 for clustering of second objects, either using implicit or explicit relationships between objects of the group (e.g., second objects). The predetermined relationship can be a position-based relationship (e.g., interaction). The group is formed, for example, based on predetermined relationships between second objects in the group. In one embodiment, the first object may be the same object as the second object. In another embodiment, the first object may be a different object than the second object. The group parameter 503, in some examples, includes predetermined relationships for a number of different second objects and/or a number of different groups. Group parameters can apply to vehicles, static or dynamic, and pedestrians (e.g., groups of pedestrians on the same crossing have an orientation that is aligned with the crossing's direction).

In one or more examples or embodiments, different group parameters are obtained by system 500, some of which may only be relevant for specific map parameters. For example, a group parameter 503 is indicative of a trailing object having a minimum distance from the object in front (e.g., a trailing car). The group parameter 503 can also be indicative of inter-class specific alignments, such as for pedestrians loading vehicles.

Based on the map parameter 502 and the group parameter 503, the system 500 determines orientation data 510. The orientation data 510 is indicative of an orientation (e.g., position) of at least one object amongst the first object and the second objects. For example, the orientation data 510 is indicative of the at least one object that is parked on the side of the road being in an orientation aligned with a direction in which the vehicle is travelling along the road. Advantageously, the system 500 can determine the orientation data 510 to supplement a sparse point cloud, and can improve detection and determination of objects in the environment by the autonomous vehicle.

The system 500 causes a device to provide object detection data 512, based on the orientation data 510, associated with the at least one object. Object detection data 512 includes for example one or more of a position, an orientation, and a size of the at least one object (e.g., spatial features). The object detection data 512, for example, is used to supplement spare data clouds for object detection, such as via objection detection system 504, and/or tracking, such as via tracker 506. In one or more examples or embodiments, the system 500 is configured to determine the object detection data 512 based on the orientation data 510.

In one or more examples or embodiments, the system 500 is configured for online operation, such as using sensor data. The system 500, in some examples, uses sensor data 501 for verification and/or checking of the determined orientation data 510. In one or more examples or embodiments, the operations further include obtaining sensor data 501 associated with the environment. In one or more examples or embodiments, the operations further include determining the orientation data 510 based on the map parameter 502, the group parameter 503, and the sensor data 501.

In one or more examples or embodiments, the system 500 obtains sensor data 501 from a sensor, such as via a perception system (such as perception system 402 of FIG. 4). The system 500 can use sensor data 501 for the determination of the orientation data 510. The sensor data 501 can be one or more of: radar sensor data, image sensor data (e.g., camera sensor data), and LIDAR sensor data. The particular type of sensor data 501 is not limiting. The sensor data 501 can be indicative of an environment around the autonomous vehicle. For example, the sensor data 501 can be indicative of an object, and/or a plurality of objects (e.g., first object, second object), in the environment in which the vehicle operates.

The sensor can be one or more sensors, such as an onboard sensor. The sensor may be associated with the vehicle. The vehicle may include one or more sensors that can be configured to monitor an environment where the vehicle operates, such as via the sensor, through sensor data 501. For example, the monitoring provides sensor data 501 indicative of what is happening in the environment around the vehicle, such as for determining the orientation data 510. The sensor can be one or more of: a radar sensor, a camera sensor, an infrared sensor, an image sensor, and a LIDAR sensor. The sensor can include one or more of the sensors illustrated in FIG. 2, such as cameras 202a, LiDAR sensors 202b, and radar sensors 202c.

In one or more examples or embodiments, the system 500 uses the sensor data 501, the map parameter 502, and the group parameter 503 for determining the orientation data 510. As the sensor data 501 may include sparse data, such as a sparse point cloud from a LiDAR, the map parameter 502 and group parameter 503 can supplement. Further, the system 500 can utilize sensor data 501, such as real-time sensor data, for the determination and/or verification of the orientation data 510. Further, the sensor data 501 can be used for improved accuracy of the determination of orientation data 510.

In one or more examples or embodiments, the system 500 obtains the sensor data 501 for other purposes, such as for obtaining the group parameter 503. In one or more examples or embodiments, obtaining the group parameter 503 includes determining, based on the sensor data 501, distances between the second objects (e.g., objects in the group).

In one or more examples or embodiments, obtaining the group parameter 503 includes clustering, based on the distances, the second objects to form the group. The system 500, for example, determines pairwise distances between second objects. The system 500 for example determines a pairwise distance matrix of all pedestrians in the environment. In one or more examples or embodiments, the system 500 uses clustering techniques to extract the group, so that the system 500 does not need to individually track each second object of the group. If the distances between the second objects meet or is below a clustering threshold, the system 500 is configured to cluster the second objects to form the group. If the distances between the second objects do not meet a clustering threshold (e.g., are above the clustering threshold), the system 500 is configured to not cluster the second objects to form the group. For example, if the autonomous vehicle is located near a cross walk, a number of pedestrians may cross the cross walk. Instead of individually determining and/or tracking each of the pedestrians as a separate object, which may require high computational power and cause inconsistencies between the results associated to each pedestrian, the system 500 is configured to cluster the pedestrians together as a single group.

In one or more examples or embodiments, the operations further include discarding, based on the group parameter 503 and the map parameter 502, a group from the object detection data 512. In other words, the system 500 can be configured to filter out non-relevant groups and/or objects, such as those that are not in relevant map regions (e.g., objects that are in parking lots, roadside parking, before stop line are relevant map regions. Relevant map regions may be obtained by the system 500. For example, the system 500 determines whether the group meets a detection criteria. The detection criteria can be indicative of non-relevant regions, such as based on one or more of the sensor data 501, the map parameter 502, and the group parameter 503. For example, in response to determining that the group does not meet the detection criteria, the system 500 is configured to discard the group from the object detection data 512. For example, in response to determining that the group does meet the detection criteria, the system 500 is configured to not discard the group from the object detection data 512. This may advantageously reduce processing of groups that are not relevant for operation of the autonomous vehicle.

In one or more examples or embodiments, determining, based on the map parameter 502 and the group parameter 503, the orientation data 510 includes extracting, based on the sensor data 501 and the group parameter 503, one or more line patterns associated with the first object and/or the second objects. In one or more examples or embodiments, the system 500 applies Hough transformation to identify one or more line patterns of an object in the environment. A Hough transformation can be seen as a feature extraction technique that can be used to find lines in general, and can be used on vehicle locations to gather aligned vehicles together as being on the same line. The line patterns, in some examples, allows the system 500 to further discard non-relevant objects in the environment. In one or more examples or embodiments, determining, based on the map parameter 502 and the group parameter 503, the orientation data 510 includes discarding, based on the one or more line patterns, one or more lines associated with the first object and/or the second objects (e.g., objects in the group). The system 500, in some examples, discards lines that have irregular spacing between vehicles or incompatible orientations. The line patterns may be one dimensional (such as roadside parking), two dimensional, or three dimensional. The system 500 can be configured to detect regular line lattices (e.g., parking lot). For example, the system 500 determines whether the line patterns meet a line criteria. In response to determining that the group does not meet the line criteria, the system 500 is configured to not consider that objects that are not on the same line are part of the same group (such as discard the one or more lines). In response to determining that the group does meet the line criteria, the system 500 is configured to not discard the one or more lines, and can mark the corresponding objects as belonging to the same group. This can advantageously create consistent object group that shares similar features.

In one or more examples or embodiments, determining, based on the map parameter 502 and the group parameter 503, the orientation data 510 includes aligning, based on the one or more line patterns, at least one object amongst the first object and the second objects. In one or more examples or embodiments determining, based on the map parameter 502 and the group parameter 503, the orientation data 510 includes determining, based on the alignment, the orientation data 510. For example, the system 500 can make determinations of alignment between the first object and the second objects. This may be advantageous for improving determination of the orientation parameter, as certain objects may have particular alignments in the environment.

For example, the system 500 aligns objects that form a line (e.g., roadside parking) or a regular two-dimensional lattice (e.g., parking lot). The alignment may also be used for curved roads which would have a curved line. For example, the system 500 defines the orientation parameter as relative to the road direction.

In one or more examples or embodiments, the system 500 determines the orientation parameter based on the alignment. This may allow for the refining of object orientations, especially from pre-existing map parameters. For example, vehicles in a parking lot (as indicative by the first object and/or the second objects) typically share the same orientation, with a potential variation of 180 degrees. However, one out-of-place vehicle may affect the other vehicles in a parking lot. The alignment may be used for rectifying the orientation data 510 with respect to objects that may not fit within the map parameter 502 or the group parameter 503. Similar situations may occur for vehicles parked along the road, which are supposed to follow the road direction and orientation, but may not in actuality.

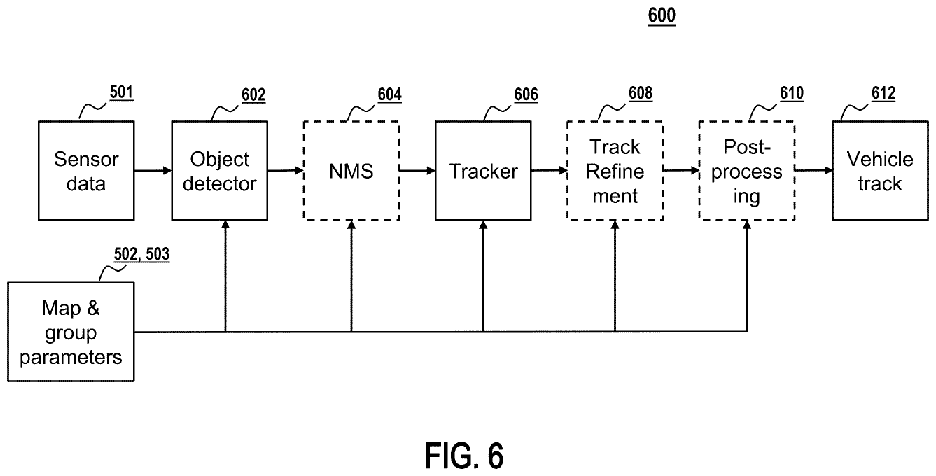

In one or more examples or embodiments, the system 500 can be utilized at different points in the pipeline, in particular the labelling pipeline. FIG. 6 is a diagram of an example implementation of a process for object orientation determination along a labelling pipeline 600. The labelling pipeline can include an object detector 602 (such as similar to object detection system 504 of FIG. 5), a non-maximum suppression scheme 604 (NMS, such as similar to NMS 505 of FIG. 5), a tracker 606 (such as similar to tracker 506 of FIG. 5), a tracker refinement 608, and post-processing 610 (such as similar to post-processing system 507 of FIG. 5).

In one or more examples or embodiments, the operations further include improving, using the at least one processor, the object detection data 512 with map layer information based on the map parameter 502 and/or the group parameter 503. In one or more examples or embodiments, the system 500 improves in the object detector 602. The map layer may be seen as a semantic layer that is obtained by the system 500, for example a bird's eye view of a particular environment. The map layer, for example, is indicative of a ground truth of the environment. In one or more examples or embodiments, the operations further include improving, using the at least one processor, the object detection data 512 thanks to map layer information based on the map parameter 502 and the group parameter 503. In one or more examples or embodiments the operations further include improving, using the at least one processor, the object detection data 512 with map layer information based on the map parameter 502 or the group parameter 503. The improvement may be part of, or fully, fusing of different data.

Advantageously, the system 500 can be implemented in multiple levels. For example, during early fusion, the LiDAR point cloud (such as via sensor data 501) is improved with information about what map layer a particular point in the point code is on. During a mid-fusion procedure, one or more map layers (such as raster and/or vector maps) can be obtained by the system 500, such as input for a machine-learning model. For example, the map layer can be used as an additional channel of the pseudo-image in an encoder used for object detection in a point cloud (e.g., PointPillars described in the publication, A. H. Lang et al. “PointPillars: Fast Encoders for Object Detection from Point Clouds”, arXiv:1812.05784v2, May 2019, incorporated herein by reference).

The system 500 can be configured to use any neural network that takes in an organized point-cloud as input. For example, on top of the organized LIDAR point-cloud (which is a pseudo image, like PointPillars' input), the neural network can also take a pseudo image that has the same dimension as the LIDAR pseudo-image, which depicts the map of the scene. The system 500 can be configured to use the map layer as a map region filter. For example, the system 500 uses the drivable area mask of the map to remove any detections outside of it, which can yield increased processing speeds, and can be performed on boxes or points.

In one or more examples or embodiments the operations further include performing, using the at least one processor, based on the group parameter 503, a non-maximum suppression scheme (NMS) 505, 604 on the object detection data 512. The system 500, for example, uses the NMS 505, 604 to remove duplicate detections made by the network. Group priors can be used to inform the NMS setting, such as to avoid removing detection on vehicles parked closely to one another. For example, the Non-Maximum Suppression (NMS) algorithm would use a less restrictive intersection over union (IoU threshold), and would thus preserve more objects as boxes that correspond to vehicles that are close to each other are likely to share a relatively high IoU score. The system can use map and group priors to bias the threshold on the detection scores prior to NMS 505, 604 for boxes that are in-line, or not in line, with the regular spacing or alignment of a group, so that boxes with low-confidence detection but that are coherent with regards to a group are still considered being considered in the NMS step. In other words, before NMS, in locations in which there is a group, the system 500 is configured to keep more boxes. In some examples, each box is associated with a confidence score, and boxes with low confidence scores are discarded, and so when there are groups, the system 500 is configured to keep boxes with lower confidence scores. Then, the list of boxes that were kept can be refined via NMS.

In one or more examples or embodiments the operations further include tracking, using the at least one processor, based on the orientation data 510 and the sensor data 501, one or more objects in the environment. The system 500 is for example configured to perform tracking in the tracker 606 and/or during tracker refinement 608. For example, the system 500, in the tracker 606, uses probability distributions over the location and/or orientation to alter a Kalman filter update step (e.g., to bias a vehicle towards the center of a lane). As another example, the system 500, in the tracker refinement 608, refines the pose, size, and/or orientation of an entire track over time. The system 500 can use the group and map parameters (such as in early fusion and/or mid-fusion) to implicitly incorporate them.

In one or more examples or embodiments the operations further include determining, using the at least one processor, based on the sensor data 501 and the orientation data 510, control data for control of the autonomous vehicle. The control data is for example used for controlling operation of the vehicle. The system 500, for example, provides the control data to a control system of an autonomous vehicle (such as control system 408 in FIG. 4). The system 500 transmits, for example, control data to, e.g., a control system of an autonomous vehicle and/or an external system. The system 500 can transmit the control data to the vehicle track 612 shown in FIG. 6.

In one or more examples or embodiments, the operations further include determining, using the at least one processor, based on the orientation data 510 and the sensor data 501, a labelling of at least one object in the environment. In other words, the system 500 is for example configured to apply labels to objects in the environment. Advantageously, the system 500, either offline or online, can improve internal labelling of objects, which in turn may improve operation of the autonomous vehicle. The labelling can be used for further object detection and labeling, which can improve the quality of labelling by the system 500. For example, the system 500 labels the at least one object via object detection system 504.

In one or more examples or embodiments, the system 500 is configured to apply one or more post-processing 610, such as before any vehicle tracking 612. In one or more examples or embodiments, the operations further include updating, using the at least one processor, based on the orientation data 510, a machine-learning model. The machine-learning model may be a neural network, such as CNN 420 of FIG. 4B or CNN 440 of FIG. 4C-4D. The system 500, for example, trains the machine-learning model based on the orientation data 510. This training can be performed offline. Alternatively, or in conjunction, the training can be performed online using the sensor data 501. In one or more example or embodiments, updating the machine-learning model allows for improvements of tracker and/or tracker refinement networks, and/or in any post-processing functions. In one or more examples or embodiments, updating the machine-learning model includes inputting into the machine-learning model one or more of: the orientation data 510, one or more object parameters, the group parameter 503, and the map parameter 502. In one or more examples or embodiments, updating the machine-learning model includes outputting, by the machine-learning model, an updated orientation data. In one or more examples or embodiments, updating the machine-learning model includes recursively applying the updated orientation data in place of the orientation data 510. The updated orientation data can be improved over the original orientation data 510 by the machine-learning model. A machine-learning model, such as fully connected neural network can be used for implicit post-processing. The one or more object parameters, for example, include box size, location, and/or score associated with the first object and/or the second objects, and can be used as inputs into the machine-learning model. The system 500, for example, determines the one or more object parameters and/or obtains the one or more object parameters.

The machine-learning model can output updated object parameters. Recursively applying, by the system 500, can include constantly refreshing and updating data in the machine-learning model (e.g., iterations). The system 500, for example, recursively applies until convergence or until a set number of iterations. In one or more examples or embodiments, the system 500 uses a PointNet-like network for a variable number of objects in the group. A PointNet-like network can be seen as neural networks that detect LIDAR objects (e.g., a network that process points or point neighbourhoods individually, and extract global features out of them). For example, PointNet (described, e.g., in C. R. Qi et al., “PointNet: Deep Learning on Point Sets for 3D Classification and Segmentation”, Apr. 10, 2017, arXiv:1612.00593v2, incorporated herein by reference) is a neural network architecture that is specifically designed to process unordered point-clouds.

In one or more examples or embodiments, the operations further include obtaining, using the at least one processor, one or more estimated object parameters. In one or more examples or embodiments, the operations further include comparing, using the at least one processor, the one or more estimated object parameters and the orientation data 510. In one or more examples or embodiments, the operations further include determining, using the at least one processor, based on the comparison, a differential parameter indicative of a difference in orientation between the one or more estimated object parameters and the orientation data 510. In one or more examples or embodiments, the operations further include updating, using the at least one processor, based on the differential parameter, the orientation data 510. This process can be known as post processing 610, such as rule-based or explicit post processing. For example, the system 500 compares the one or more estimated object parameters and the orientation data 510 to see whether the “expected” object parameters match what is actually indicated by the orientation data 510, such as from the map parameter 502. If the difference between one or more estimated object parameters (e.g. the orientation data 510) and the map parameter 502 is within a threshold, the system 500 updates the one or more estimated object parameters and/or the orientation data 510 based on the map parameter 502. If the difference between one or more estimated object parameters and the map parameter 502 is not within a threshold (e.g., the differential parameter) from the map parameter 502, the system 500 does not update the one or more estimated object parameters and/or the orientation data 510 based on the map parameter 502. As an example, if the orientation of a detected parked car that lies on the side of the road is close to the orientation of the road, the system 500 is configured to determine that the orientation data 510 of the parked car is in fact equal to the orientation of the angle.

In one or more examples or embodiments, the system 500 obtains the one or more estimated object parameters from a database (for example database 410 of FIG. 4). The one or more estimated object parameters can be indicative of orientation of one or more objects, such as first object or second object. The system 500, in some examples, compares the one or more estimated object parameters and the orientation data 510. This can be useful to determine how accurate the system 500. Based on the comparison, the system 500 can determine the differential parameter, which can be a numerical representation of the accuracy of the system 500 for the orientation data 510.

In one or more examples or embodiments, the operations further include estimating, using the at least one processor, based on the map parameter 502 and/or the group parameter 503, a probability distribution of the orientation data 510. In one or more examples or embodiments, the operations further include determining, using the at least one processor, based on the probability distribution of the orientation data 510, the object detection data 512. For example, the system 500 uses Bayesian interference in post processing 610. The system 500, for example, modifies the object detector 602 to output a probability distribution over the estimated box parameters (e.g., position, orientation, size). This computation can be simplified by modeling position, orientation and size independently. A probability distribution of these parameters for each type of map parameter 502, for example, is estimated by the system 500 (e.g., the vehicle orientation at a particular position on a lane). The system 500 can fuse the map parameter 502 and the estimated box parameters via the use of Bayes' theorem, to compute a posterior probability. In one or more examples or embodiments, the system 500 uses probabilities for determining the object detection data 512.

In one or more examples or embodiments, the operations further include determining, using the at least one processor, based on the sensor data 501, at least one ground-truth object in the environment. In one or more examples or embodiments, the operations further include determining, using the at least one processor, based on the sensor data 501, an object orientation data indicative of ground-truth orientation of the at least one ground-truth object. In one or more examples or embodiments, the operations further include determining, using the at least one processor, based on a comparison of the object orientation data and the orientation data 510, a confidence parameter indicative of a difference in orientation between the object orientation data and the orientation data 510. In one or more examples or embodiments, the operations further include updating, using the at least one processor, based on the confidence parameter, the orientation data 510. In other words, uncertainty modelling can be used, such as through the use of confidence intervals (e.g., confidence parameters. For example, the system 500 uses disagreements of priors and observations to model the uncertainty of objects in the environment for active learning, such as to improve future detectors. As an example, the system 500 determining that vehicles are on grass is likely to be a false positive, and the system 500 determining a gap in a detected line of vehicles likely indicates a false negative. In one or more examples or embodiments, the position, orientation, and/or size of the confidence parameter increases with a larger group size and/or over a larger time horizon. For example, if the system 500 determines that nine vehicles are perfectly aligned in a parking lot, the system 500 expects a vehicle in the tenth parking spot to have a similar orientation. The system 500 can update itself, to one or more of: correct object orientation assumptions, improve object detection, train the machine-learning model, and/or improve data fusion (e.g., early and/or mid fusion).

In one or more examples or embodiments, the ground-truth object is an accurate object in the environment, such as an object that actually exists in the environment. The system 500 can use sensor data 501 for such a determination. The system, for example, determines an object orientation data of the ground-truth object which is indicative of an accurate orientation of the object in the environment. Further, in some examples the system is configured to compare the object orientation data with the orientation data 510 (e.g., compares the “true” object orientation with the orientation the system 500 has determined, such as without sensor data 501). This comparison is represented by the confidence parameter, which the system 500 can then use to update the orientation data 510 if needed.

In one or more examples or embodiments, the map parameter 502 is indicative of a region of the environment. In one or more examples or embodiments, the group parameter 503 is indicative of the predetermined relation in the region. For example, group parameters may only be relevant for a specific map region (e.g., area, location, boundary, interaction), such as a curved road, a loading area, and/or a pedestrian crossing.

In one or more examples or embodiments, the first object is a first static object. In one or more examples or embodiments, the second object is a second static object. In one or more examples or embodiments, the first object is a first moving object. In one or more examples or embodiments, the second object is a second moving object. The first object may be a static object and the second object may be a dynamic object. The first object may be a dynamic object and the second object may be a static object.

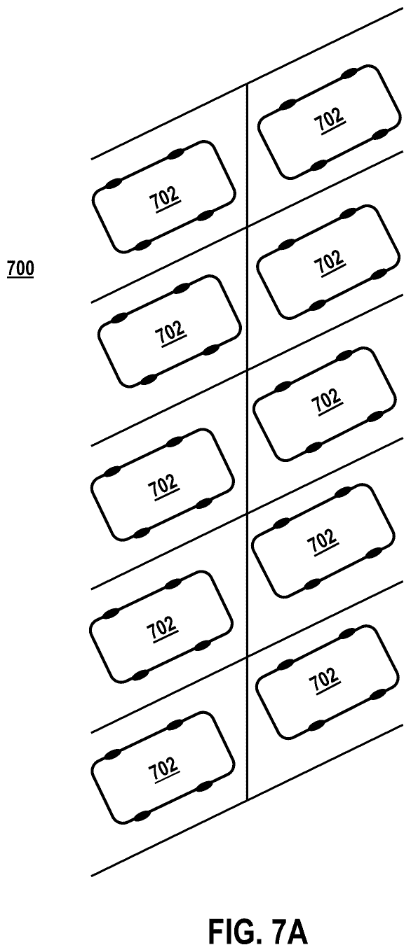

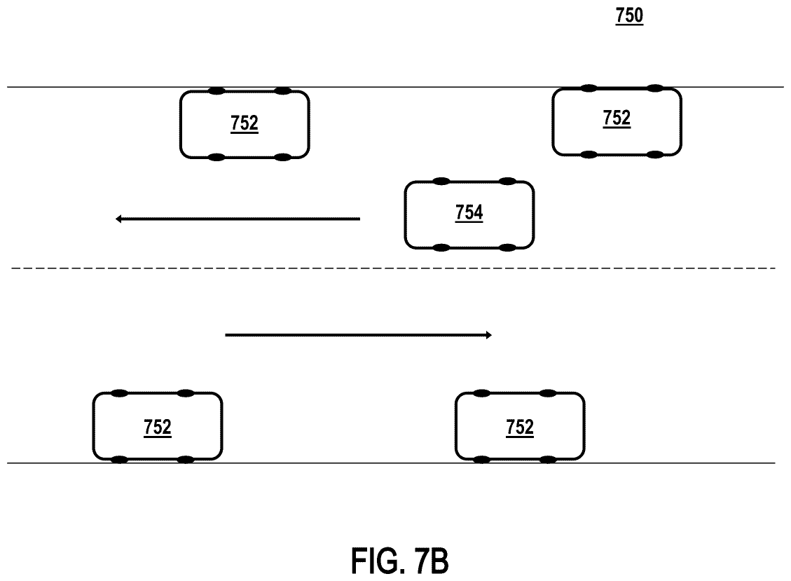

FIGS. 7A-7B are diagrams of an example group parameters that may be used for object orientation determination. FIG. 7A illustrates an example parking lot 700. As shown, the vehicles 702 in the parking lot 700 share the same orientation (+/−180 degrees). This is an example of a group parameter where the system 500 determines interactions between second objects of a group, namely their relative positioning in a parking lot 700. FIG. 7B illustrates a roadway 750 with vehicles 752 parked along the side of the roadway 750, and vehicle 754 legally driving on the roadway 750. The group parameter for example indicates that vehicles parked along the roadway 750 are supposed to follow the road direction and orientation.

Referring now to FIG. 8, illustrated is a flowchart of a method or process 800 for object orientation determination, such as for operating and/or controlling an AV. The method can be performed by a system disclosed herein, such as an AV compute 202f of FIG. 2 and AV compute 400 of FIG. 4, a vehicle 102, 200, of FIGS. 1 and 2, respectively, device 300 of FIG. 3, and AV compute 540 of FIG. 5 and implementations of FIGS. 6, and 7A-7B. The system disclosed can include at least one processor which can be configured to carry out one or more of the operations of method 800. The method 800 can be performed (e.g., completely, partially, and/or the like) by another device or group of devices separate from or including system disclosed herein.

The method 800 includes obtaining, at step 802, using at least one processor, a map parameter indicative of a predetermined position of a first object in an environment where an autonomous vehicle is configured to operate. In one or more embodiments or examples, the method 800 includes obtaining, at step 804, using the at least one processor, a group parameter indicative of a predetermined relation between objects of a group. In one or more embodiments or examples, the environment includes the objects. In one or more embodiments or examples, the method 800 includes determining, at step 806, using the at least one processor, based on the map parameter and the group parameter, orientation data indicative of an orientation of at least one object amongst the first object and the objects. In one or more embodiments or examples, the method 800 includes causing, at step 808, using the at least one processor, object detection data associated with the at least one object to be provided to a device based on the orientation data, wherein the object detection data is indicative of detection of one or more spatial features of the at least one object. In some cases, the device can include a control system of an AV and providing the object detection data can cause control of the AV based on the object detection data associated with the at least one object (e.g., one object in the environment whose orientation is indicated by the orientation data). As such, in some cases, the method 800 may include causing control of the AV based on the object detection data associated with the at least one object.

In one or more embodiments or examples, the method 800 includes obtaining, using the at least one processor, sensor data associated with the environment. In one or more embodiments or examples, the method 800 includes determining, at step 806, using the at least one processor, the orientation data based on the map parameter, the group parameter, and the sensor data.

In one or more embodiments or examples, obtaining, at step 804, the group parameter includes determining distances between the objects based on the sensor data. In one or more embodiments or examples, obtaining, at step 804, the group parameter includes clustering, based on the distances, the objects to form the group.

In one or more embodiments or examples, the method 800 includes discarding, based on the group parameter and the map parameter, a group from the object detection data.

In one or more embodiments or examples, determining, at step 806, based on the map parameter and the group parameter, the orientation data includes extracting, based on the sensor data and the group parameter, one or more line patterns associated with the first object and/or the objects.

In one or more embodiments or examples, determining, at step 806, based on the map parameter and the group parameter, the orientation data includes discarding, based on the one or more line patterns, one or more lines associated with the first object and/or the objects.

In one or more embodiments or examples, determining, at step 806, based on the map parameter and the group parameter, the orientation data includes aligning, based on the one or more line patterns, at least one object amongst the first object and the objects. In one or more embodiments or examples, determining, at step 806, based on the map parameter and the group parameter, the orientation data includes determining, based on the alignment, the orientation data.

In one or more embodiments or examples, the method 800 includes improving, using the at least one processor, the object detection data with map layer information based on the map parameter and/or the group parameter.

In one or more embodiments or examples, the method 800 includes performing, using the at least one processor, based on the group parameter, a non-maximum suppression scheme on the object detection data.

In one or more embodiments or examples, the method 800 includes tracking, using the at least one processor, based on the orientation data and the sensor data, one or more objects in the environment.

In one or more embodiments or examples, the method 800 includes determining, using the at least one processor, based on the sensor data and the orientation data, control data for control of the autonomous vehicle.

In one or more embodiments or examples, the method 800 includes determining, using the at least one processor, based on the orientation data and the sensor data, a labelling of the at least one object in the environment.

In one or more embodiments or examples, the method 800 includes updating, using the at least one processor, based on the orientation data, a machine-learning model.

In one or more embodiments or examples, updating the machine-learning model includes inputting into the machine-learning model one or more of: the orientation data, one or more object parameters, the group parameter, and the map parameter. In one or more embodiments or examples, updating the machine-learning model includes outputting, by the machine-learning model, an updated orientation data. In one or more embodiments or examples, updating the machine-learning model includes recursively applying the updated orientation data in place of the orientation data.

In one or more embodiments or examples, the method 800 includes obtaining, using the at least one processor, one or more estimated object parameters. In one or more embodiments or examples, the method 800 includes comparing, using the at least one processor, the one or more estimated object parameters and the orientation data. In one or more embodiments or examples, the method 800 includes determining, using the at least one processor, based on the comparison, a differential parameter. In one or more embodiments or examples, the differential parameter is indicative of a difference in orientation between the one or more estimated object parameters and the orientation data. In one or more embodiments or examples, the method 800 includes updating, using the at least one processor, based on the differential parameter, the orientation data.

In one or more embodiments or examples, the method 800 includes estimating, using the at least one processor, based on the map parameter and/or the group parameter, a probability distribution of the orientation data. In one or more embodiments or examples, the method 800 includes determining, using the at least one processor, based on the probability distribution of the orientation data, the object detection data.

In one or more embodiments or examples, the method 800 includes determining, using the at least one processor, at least one ground-truth object in the environment based on the sensor data. In one or more embodiments or examples, the method 800 includes determining, using the at least one processor, an object orientation data indicative of ground-truth orientation of the at least one ground-truth object based on the sensor data. In one or more embodiments or examples, the method 800 includes determining, using the at least one processor, based on a comparison of the object orientation data and the orientation data, a confidence parameter. In one or more embodiments or examples, the confidence parameter is indicative of a difference in orientation between the object orientation data and the orientation data. In one or more embodiments or examples, the method 800 includes updating, using the at least one processor, based on the confidence parameter, the orientation data.

In one or more embodiments or examples, the map parameter is indicative of a region of the environment. In one or more embodiments or examples, the group parameter is indicative of the predetermined relation in the region.

In one or more embodiments or examples, the first object is a first static object and the object is a second static object.

In one or more embodiments or examples, the first object is a first moving object and the object is a second moving object.

In the foregoing description, aspects and embodiments of the present disclosure have been described with reference to numerous specific details that can vary from implementation to implementation. Accordingly, the description and drawings are to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction. Any definitions expressly set forth herein for terms contained in such claims shall govern the meaning of such terms as used in the claims. In addition, when we use the term “further comprising,” in the foregoing description or following claims, what follows this phrase can be an additional step or entity, or a sub-step/sub-entity of a previously-recited step or entity.

Disclosed are non-transitory computer readable media comprising instructions stored thereon that, when executed by at least one processor, cause the at least one processor to carry out operations according to one or more of the methods disclosed herein.

### Example Autonomous Vehicle (AV) Compute System

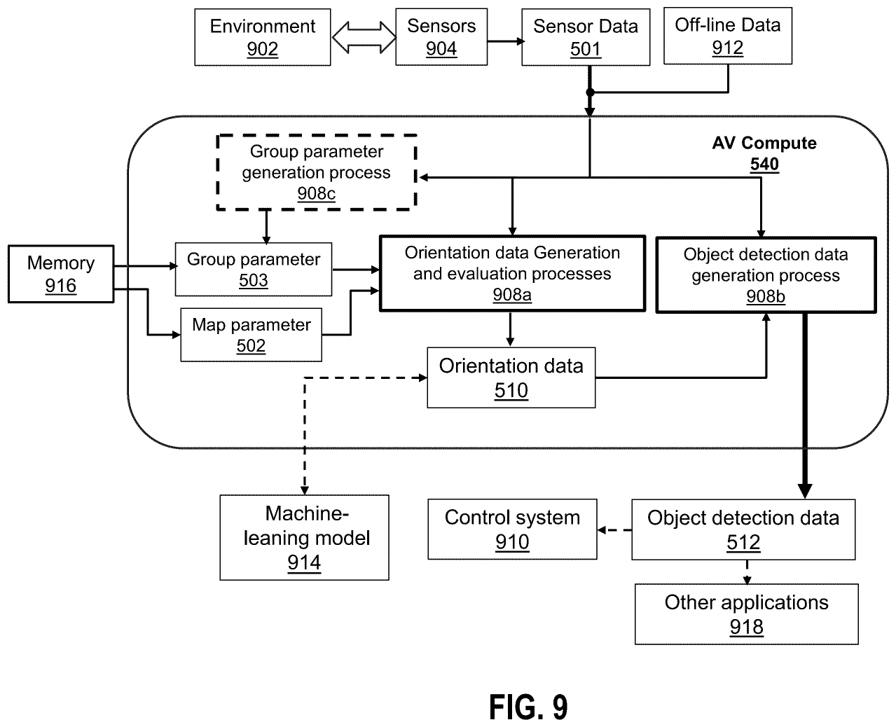

FIG. 9 is a block diagram illustrating example processes that may be performed by the AV compute 540 that generates orientation data 510 (indicative of an orientation of at least one object) and object detection data 512 (associated with the at least one object to be provided to a device based on the orientation data 510) based at least in part on group parameter 503 and map parameter 502. The AV compute 540 may include at least one processor and at least one memory storing instructions thereon that, when executed by the at least one processor, cause the at least one processor to perform these processes. In some cases, the device to which the object detection data 512 is provided can be a control system 910 of an autonomous vehicle (AV) and may cause the AV to be controlled based on the object detection data 512 that is augmented and/or modified with the orientation data 510.

In some implementations, the AV compute 540 may perform a process using one or more of the object detection system 504, NMS 505, the tracker 506, and the post processing system 507. It will be understood that the AV compute 540 may perform other processes and generate and/or output other types of data and control commands, and other implementation variations are possible.

In various implementations, the AV compute 540 may use map parameter(s) 502 and/or group parameter(s) 503 to perform these processes. For example, the AV compute 540 may use the map parameter(s) 502 and/or group parameter(s) 503 as additional cues or indicators usable for object detection in terms of position, orientation, and size of the objects. In some examples, one or both of the map parameter 502 and group parameter 503 may be stored in a memory 916 (e.g., a non-transitional memory of the AV) or on a distributed network, such as a cloud network. In some examples, the memory 916 can be a memory of the AV compute 540. In some examples, the group parameter 503 could have been generated using a set of heuristics, or geometrical algorithms (e.g., by a processor of the AV compute 540 or another system). In some examples, the set of heuristics, or geometrical algorithms can be used to extract and/or determine group parameter could have been determined based on previously collected sensor data. In some other examples, the group parameter 503 may be generated by the AV compute 540, e.g., using the sensor data 501 received from one of the sensors 904 the AV. In some cases, map parameter 502 may have been extracted and/or determines using from previously collected sensor data. In some implementations, map parameter(s) 502 can be indicative of a predetermined position of one object (e.g., a first object or a lead object) or a group of objects in an environment 902 where an autonomous vehicle is configured to operate. In some cases, a first object of a map parameter 502 can be a feature of the environment that can lead to a position and/or orientation of another object of associated with the map parameter 502, e.g., with respect to the first object. In some cases, group parameter(s) 503 can be indicative of predetermined relationships between two or more objects (e.g., the second objects) forming a group. In some cases, an object (e.g., a lead object, or a first object such as the first object of a map parameter), can lead to positions and/or orientations of other objects of the group via their predetermined relationships.

In a nonlimiting implementation, the processes performed by the AV compute 540 can include: orientation data generation and evaluation processes 908a, object detection data generation process 908b, and group parameter generation process 908c.

Orientation data generation and evaluation processes 908a may include generating orientation data 510 based at least in part on the map parameter 502 and/or group parameter 503, and/or evaluating the accuracy or reliability of the orientation data 510. In some cases, the AV compute 540 may generate the orientation data 510 using the map parameter 502, group parameter 503, and/or sensor data 501.

In some cases, the AV compute 540 can generate the orientation data 510 by determining at least an orientation of at least one object associated with a group associated with the group parameter(s) 503. In some examples, the AV compute 540 may select a group from the group parameter(s) 502 based at least in part on the map parameter 502. In some cases, the AV compute 540 may generate the orientation data 510 by determining at least an orientation of at least one object associated with a group of the group parameter(s) 502 and/or of at least one object associated with the map parameter(s) 502.

In some cases, the AV compute 540 may generate the orientation data further by extracting, based on the sensor data 501 and the group parameter 503, one or more line patterns associated with the an object associated with the map parameter 502 and/or an object associated with the group parameter 503. Subsequently, in some cases, the AV compute 540 may use the one or more line patterns to align at least one object among the objects associated with the map parameter 502 and the objects associated with the group parameter 503. In some examples, the alignment may include determination of an alignment between an object associated with the map parameter 502 and an object associated with the group parameter 503.

In some cases, evaluating the accuracy or reliability of the orientation data 510 may include comparing the orientation data 510 with a determined orientation of a ground-truth object and generating a confidence parameter indicative of a difference between the determined orientation and the orientation data 510.

In some cases, evaluating the accuracy or reliability of the orientation data 510 can include comparing the orientation data 510 with one or more estimated object parameters received from a database (for example database 410 of FIG. 4), determining a differential parameter, which can be a numerical representation of the accuracy of the system 500 for the generating orientation data 510.

In some cases, the object detection data generation process 908b may include receiving the orientation data 510 and generating the object detection data 512 based at least in part on the orientation data 510. In some examples, the object detection data 512 can be augmented or modified based on the orientation data 510. In some cases, the AV compute 540 may generate the orientation data 510 using the sensor data 501 and the orientation data 510. In some examples, the orientation data 510 may be used to filter the sensor data 501, organize or label the sensor data 501, determine the orientation and position of an object captured by the sensor data 501, or supplement the sensor data 501 (e.g., point clouds generated by a LiDAR sensor). In some case, the object detection data generation process 908b may further include:
Estimating a probability distribution of the orientation data 510. In some cases, the AV compute 540 may determine the object detection data 512 based at least in part on the estimated probability distribution of the orientation data 510.
Discarding, based on the group parameter 503 and/or the map parameter 502, an object or a group of objects (e.g., groups and/or objects in a non-relevant map region) from object detection data 512.
Labeling and identification of objects in an environment.
Generating a map layer information and improving the object detection data 512 using the map layer information.
Informing an NMS setting of the AV compute 540 to avoid removing detection of an object in a group associated with group parameter as a duplicate detection of another object in the group.

In some implementations, the AV compute 540 may perform the object detection data generation process 908b based on one or both of the group parameter 503 and the map parameter 502.

The group parameter generation process 908c may include generating group parameter 503 based at least in part the sensor data 501. In some examples, the AV compute 540 generates the group parameter 503 using clustering techniques to select one or more objects to form a group.

In some cases, the map parameter 502 may have been generated using sensor data obtained by sensors 904 (e.g., sensor data 501), or another sensor, and may indicate a predetermined position of an object in the environment 902.

In some implementations, the AV compute 540 may be used online for operation of the AV or another system that actively receives sensor data 501 and generates object detection data 512 indicative of position, orientation, and/or characteristics (e.g., size, shape, form factor, and like) of one or more objects based on the sensor data 501. In these implementations, the AV compute 540 may transmit the object detection data 512 to a control system 910 of the AV (e.g., a control system 404) that uses the object detection data 512 for navigation in the environment 902. In some cases, the AV compute 540 may cause control of the AV based on the object detection data 512 associated with at least one object whose orientation is indicated by the orientation data 510. In some cases, the sensor data 501 may be generated by one or more sensors 904 such as cameras (e.g., cameras 202a), LiDAR sensors (e.g., LiDAR sensors 202b), Radar sensors (e.g., Radar sensors 202c), and other types of sensors. The sensors 904 may receive sound waves, electromagnetic radiation (e.g., light beams, optical signals, radio frequency (RF) waves or signals, microwaves or signals, or other type of waves or signals from an environment 902 (e.g., an environment within which the AV or another system navigates or operates).

In some implementations, the AV compute 540 may be used online for operation of the AV or another system that actively receives sensor data 501 and generates object detection data 512 indicative of position, orientation, and/or characteristics (e.g., size, shape, form factor, and like) of one or more objects based on the sensor data 501. In some examples, when used online, the AV compute 540 may use the orientation data 510 to update a machine-learning model 914 used by the AV. In some cases, the machine-learning model 914 may be updated recursively by applying the updated orientation data in place of the orientation data 510. The updated orientation data can be improved over the original orientation data 510 by the machine-learning model 914.

In some implementations, the AV compute 540 may be used offline where the AV compute 540 receives and processes off-line data. In some cases, off-line data 912 can include data generated by another system or data previously generated by the sensors 904 during one or more operational periods of the AV. In some cases, in the off-line mode, the AV compute 540 may be used to generate orientation data 510 and object detection data using the off-line data 912 and provide the resulting object detection data 512 to another application 918. In some cases, in an off-line mode the AV compute 540 may be used to train a machine-learning model 914 of AV or another machine learning model based on off-line data 912. In some cases, training the machine leaning model can include updating orientation data 510 and recursively applying the updated orientation data 510 in place of the orientation data 510.

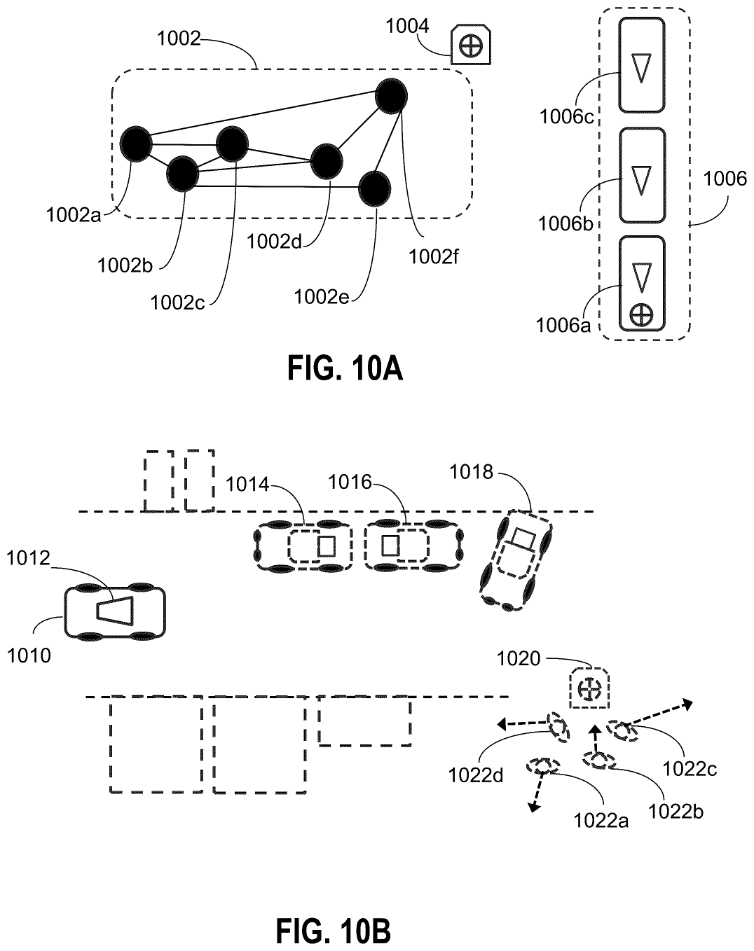

FIG. 10A is a diagram illustrating an example map parameter and an example group parameter that can be used by the AV compute 540 shown in FIG. 5 or FIG. 9 to determine orientations and/or positions of one or more objects in an environment. In some examples, the group parameter 1002 may include assumptions about relations and/or interactions among objects 1002a-1002f (depicted as solid lines connecting the objects) that form a group of the group parameter 1002. In some cases, a group of objects may be identified based on the assumed relations and/or interactions among objects 1002a-1002f. In some cases, a lead object 1004 (e.g., a static object such as a point of interest) can be linked to the group and indicate a high probability of formation of the group near the lead object 1004. In some cases, the detection of the lead object 1004 can be used to verify a group identification and/or lead to determination of the position and/or orientation of one or more objects 1002a-1002f in the group (e.g., with respect to the lead object 1004). In some cases, the objects 1006a-1006b can form a map parameter 1006 that includes assumptions about likely positions and orientations of the objects 1006a-1006c with respect to each other and with respect to a predetermined location (e.g., a location of a first object 1006a in an environment). In some such cases, detection of the first object 1006a of the map parameter 1006 may indicate an alignment, orientation, or position of the objects 1006a and 1006c.

FIG. 10B is a diagram illustrating an original perception of the environment surrounding an AV 1010 based on sensor data (e.g., on sensor data 501), and before taking into account the map and group parameters. The original perception of the environment can include objects whose orientations and/or positions can be adjusted and/or corrected using the map parameter 1006 and/or group parameter 1002 shown in FIG. 10A. In some cases, AV 1010 includes a sensor 1012 (e.g., a LiDAR or a camera) configured to monitor the environment and detect objects in the environment. In some cases, the AV 1010 may include an AV compute similar to AV compute 540 configured to generate orientation and object detection data based on map and group parameters stored in a memory of the AV 1010. The map and group parameters can include the map and group parameters 1006, 1004 described above with respect to FIG. 10A. In some cases, the sensor 1012 can generate sensor data indicative of presence of vehicles 1014, 1016, and 1018 parked on the side of the road along which the AV 1010 is moving. As shown in FIG. 10B, the originally perceived direction of the vehicle 1016, based on sensor data, can be opposite to that of the vehicle 1014 and the direction of the vehicle 1018 may be significantly tilted with respect to the first vehicle 1014 and the road border). In some examples, the AV compute 540 of the AV 1010 can identify the vehicle 1014 as a first vehicle associated with the map parameter 1006 and determine the orientation and/or position of vehicles 1016 and 1018 (e.g., with respect to vehicle 1014 and/or the road direction or road side) based on the map parameter 1006 that indicates the orientation of the second 1006b and third 1006c objects should be similar to that of the first object 1006a and the objects 1006a-1006c should be substantially parallel to each other. As such in the resulting orientation data, the orientation of second vehicle 1016 (that is perceived as being opposite to the orientation of the first vehicle 1014) may be flipped according to the expected or assumed orientation of the second object 1006b with respect to the first object 1006a. Similarly in the resulting orientation data the orientation of third vehicle 1018 (that is originally perceived as not being substantially parallel to the first vehicle 1014) may be adjusted according to the expected or assumed orientation of the third object 1006c so that it becomes parallel to the first object 1006 and thereby to the first vehicle 1014.

With continued reference to FIG. 10B, as another example, the AV compute 540 of the AV 1010 may identify the pedestrians 1022a-1022d as individual dynamic objects that independently move along different (e.g., random) directions. In some cases, the AV compute 540 can use the group parameter 1002 and a detected relationship or relative dynamics between the pedestrians 1022a-1022d (based on sensor data) to determine that they form a group (e.g., corresponding to the group parameter 1002) and there is a high probability that they move in the same direction or are oriented along a common direction. In some examples, the AV compute system can assume that a detected object 1020 has the characteristics (e.g., geometrical and spatial characteristics) of the lead object 1004 to further confirm that the pedestrians 1022a-1022d form a group associated with the group parameter 1002. For example, the object 1020 can be a traffic light and once the AV compute 540 identifies it as the lead object 1004, the pedestrians 1022a-1022d can be assumed to form a group corresponding the group parameter 1002. As such in the resulting orientation data the orientations and moving directions of the pedestrians 1022a-1022d (that are originally perceived as being random and/or independent) may be adjusted according to the expected or assumed orientation of the object 1002a-1002f with respect to each other (e.g., substantially walking along a common direction). In some cases, the orientations and moving directions of the pedestrians 1022a-1022d can be additionally adjusted with respect to the lead object 1004, and thereby a roadside with respect to which the lead object 1004 (corresponding to the detected object 1020) is statically positioned.

### Example Embodiments

Example embodiments described herein have several features, no single one of which is indispensable or solely responsible for their desirable attributes. A variety of example systems and methods are provided below.

Also disclosed are methods, non-transitory computer readable media, and systems according to any of the following items:

Example 1. A method comprising:
obtaining, using at least one processor, a map parameter indicative of a predetermined position of a first object in an environment where an autonomous vehicle is configured to operate;
obtaining, using the at least one processor, a group parameter indicative of a predetermined relation between objects of a group, wherein the environment comprises the objects;
determining, using the at least one processor, orientation data indicative of an orientation of at least one object amongst the first object and the objects based on the map parameter and the group parameter; and
causing, using the at least one processor, object detection data associated with the at least one object to be provided to a device based on the orientation data, wherein the object detection data is indicative of detection of one or more spatial features of the at least one object.

Example 2. The method of Example 1, further comprising:
obtaining, using the at least one processor, sensor data associated with the environment;
wherein determining the orientation data based on the map parameter and the group parameter comprises determining the orientation data is further based on the sensor data.

Example 3. The method of Example 2, wherein obtaining the group parameter comprises:
Determining distances between the objects based on the sensor data; and
clustering, based on the distances, the objects to form the group.

Example 4. The method of any of the preceding Examples, further comprising:
discarding, based on the group parameter and the map parameter, a group from the object detection data.

Example 5. The method of any of the preceding Examples, wherein determining, based on the map parameter and the group parameter, the orientation data comprises extracting, based on the sensor data and the group parameter, one or more line patterns associated with the first object and/or the objects.

Example 6. The method of Example 5, wherein determining, based on the map parameter and the group parameter, the orientation data comprises discarding, based on the one or more line patterns, one or more lines associated with the first object and/or the objects.

Example 7. The method of any of Examples 5-6, wherein determining, based on the map parameter and the group parameter, the orientation data comprises:
aligning, based on the one or more line patterns, at least one object amongst the first object and the objects; and determining, based on the alignment, the orientation data.

Example 8. The method of any of the preceding Examples, further comprising: improving, using the at least one processor, the object detection data with map layer information based on the map parameter and/or the group parameter.

Example 9. The method of any of the preceding Examples, further comprising: performing, using the at least one processor, based on the group parameter, a non-maximum suppression scheme on the object detection data.

Example 10. The method of any of the preceding Examples, further comprising: tracking, using the at least one processor, based on the orientation data and the sensor data, one or more objects in the environment.

Example 11. The method of any one of Examples 2-10, further comprising:
determining, using the at least one processor, based on the sensor data and the orientation data, control data for control of the autonomous vehicle.

Example 12. The method of any one of Examples 2-11, further comprising:
determining, using the at least one processor, based on the orientation data and the sensor data, a labelling of the at least one object in the environment.

Example 13. The method of any one of the preceding Examples, further comprising: updating, using the at least one processor, based on the orientation data, a machine-learning model.

Example 14. The method of Example 13, wherein updating the machine-learning model comprises:
inputting into the machine-learning model one or more of: the orientation data, one or more object parameters, the group parameter, and the map parameter;
outputting, from the machine-learning model, an updated orientation data; and recursively applying the updated orientation data in place of the orientation data.

Example 15. The method of any of the preceding Examples, further comprising:
obtaining, using the at least one processor, one or more estimated object parameters;
comparing, using the at least one processor, the one or more estimated object parameters and the orientation data;
determining, using the at least one processor, based on the comparison, a differential parameter indicative of a difference in orientation between the one or more estimated object parameters and the orientation data; and
updating, using the at least one processor, based on the differential parameter, the orientation data.

Example 16. The method of any of the preceding Examples, further comprising:
estimating, using the at least one processor, based on the map parameter and/or the group parameter, a probability distribution of the orientation data; and
determining, using the at least one processor, based on the probability distribution of the orientation data, the object detection data.

Example 17. The method of any of the preceding Examples, further comprising: determining, using the at least one processor, at least one ground-truth object in the environment based on the sensor data;
determining, using the at least one processor, an object orientation data indicative of ground-truth orientation of the at least one ground-truth object based on the sensor data;
determining, using the at least one processor, based on a comparison of the object orientation data and the orientation data, a confidence parameter indicative of a difference in orientation between the object orientation data and the orientation data; and
updating, using the at least one processor, the orientation data based on the confidence parameter.

Example 18. The method of any of the preceding Examples, wherein the map parameter is indicative of a region of the environment, and wherein the group parameter is indicative of the predetermined relation in the region.

Example 19. The method of any of the preceding Examples, wherein the first object is a first static object and the object is a second static object.

Example 20. The method of any of Examples 1-18, wherein the first object is a first moving object and the object is a second moving object.

Example 21. The method of any of the preceding Examples, further comprising
determining, using the at least one processor, the object detection data based on the orientation data.

Example 22. A non-transitory computer readable medium comprising instructions stored thereon that, when executed by at least one processor, cause the at least one processor to carry out operations comprising:
obtaining a map parameter indicative of a predetermined position of a first object in an environment where an autonomous vehicle is configured to operate;
obtaining a group parameter indicative of a predetermined relation between objects of a group, wherein the environment comprises the objects;
determining, based on the map parameter and the group parameter, orientation data indicative of an orientation of at least one object amongst the first object and the objects; and
causing object detection data associated with the at least one object to be provided to a device based on the orientation data, wherein the object detection data is indicative of detection of one or more spatial features of the at least one object.

Example 23. The non-transitory computer readable medium of Example 22, the operations further comprise:
obtaining, using the at least one processor, sensor data associated with the environment;
wherein determining the orientation data based on the map parameter and the group parameter comprises determining the orientation data is further based on the sensor data.

Example 24. The non-transitory computer readable medium of Example 23, wherein obtaining the group parameter comprises:
determining, distances between the objects based on the sensor data; and clustering, based on the distances, the objects to form the group.

Example 25. The non-transitory computer readable medium of any of Examples 22-24, wherein the operations further comprise:
discarding, based on the group parameter and the map parameter, a group from the object detection data.

Example 26. The non-transitory computer readable medium of any of Examples 22-25, wherein determining, based on the map parameter and the group parameter, the orientation data comprises extracting, based on the sensor data and the group parameter, one or more line patterns associated with the first object and/or the objects.

Example 27. The non-transitory computer readable medium of Example 26, wherein determining, based on the map parameter and the group parameter, the orientation data comprises discarding, based on the one or more line patterns, one or more lines associated with the first object and/or the objects.

Example 28. The non-transitory computer readable medium of any of Examples 26-27, wherein determining, based on the map parameter and the group parameter, the orientation data comprises:
aligning, based on the one or more line patterns, at least one object amongst the first object and the objects; and
determining, based on the alignment, the orientation data.

Example 29. The non-transitory computer readable medium of any of Examples 22-28, wherein the operations further comprise:
improving, using the at least one processor, the object detection data with map layer information based on the map parameter and/or the group parameter.

Example 30. The non-transitory computer readable medium of any of Examples 22-29, wherein the operations further comprise:
performing, using the at least one processor, based on the group parameter, a non-maximum suppression scheme on the object detection data.

Example 31. The non-transitory computer readable medium of any of Examples 22-30, wherein the operations further comprise:
tracking, using the at least one processor, based on the orientation data and the sensor data, one or more objects in the environment.

Example 32. The non-transitory computer readable medium of any one of Examples 23-31, wherein the operations further comprise:
determining, using the at least one processor, based on the sensor data and the orientation data, control data for control of the autonomous vehicle.

Example 33. The non-transitory computer readable medium of any one of Examples 23-32, wherein the operations further comprise:
determining, using the at least one processor, based on the orientation data and the sensor data, a labelling of the at least one object in the environment.

Example 34. The non-transitory computer readable medium of any of Examples 22-33, wherein the operations further comprise:
updating, using the at least one processor, based on the orientation data, a machine-learning model.

Example 35. The non-transitory computer readable medium of Example 34, wherein updating the machine-learning model comprises:
inputting into the machine-learning model one or more of: the orientation data, one or more object parameters, the group parameter, and the map parameter;
outputting, from the machine-learning model, an updated orientation data; and recursively applying the updated orientation data in place of the orientation data.

Example 36. The non-transitory computer readable medium of any of Examples 22-35, wherein the operations further comprise:
obtaining, using the at least one processor, one or more estimated object parameters; comparing, using the at least one processor, the one or more estimated object parameters and the orientation data;
determining, using the at least one processor, based on the comparison, a differential parameter indicative of a difference in orientation between the one or more estimated object parameters and the orientation data; and
updating, using the at least one processor, based on the differential parameter, the orientation data.

Example 37. The non-transitory computer readable medium of any of Examples 22-36, wherein the operations further comprise:
estimating, using the at least one processor, based on the map parameter and/or the group parameter, a probability distribution of the orientation data; and
determining, using the at least one processor, based on the probability distribution of the orientation data, the object detection data.

Example 38. The non-transitory computer readable medium of any of Examples 22-37, wherein the operations further comprise:
determining, using the at least one processor, at least one ground-truth object in the environment based on the sensor data;
determining, using the at least one processor, an object orientation data indicative of ground-truth orientation of the at least one ground-truth object based on the sensor data;
determining, using the at least one processor, based on a comparison of the object orientation data and the orientation data, a confidence parameter indicative of a difference in orientation between the object orientation data and the orientation data; and
updating, using the at least one processor, the orientation data based on the confidence parameter.

Example 39. The non-transitory computer readable medium of any of Examples 22-38, wherein the map parameter is indicative of a region of the environment, and wherein the group parameter is indicative of the predetermined relation in the region.

Example 40. The non-transitory computer readable medium of any of Examples 22-39, wherein the first object is a first static object and the object is a second static object.

Example 41. The non-transitory computer readable medium of any of Examples 22-39, wherein the first object is a first moving object and the object is a second moving object.

Example 42. The non-transitory computer readable medium of any of Examples 22-41, the operations further comprising determining the object detection data based on the orientation data.

Example 43. A system, comprising at least one processor and at least one memory storing instructions thereon that, when executed by the at least one processor, cause the at least one processor to perform operations comprising:
obtaining a map parameter indicative of a predetermined position of a first object in an environment where an autonomous vehicle is configured to operate;
obtaining a group parameter indicative of a predetermined relation between objects of a group, wherein the environment comprises the objects;
determining based on the map parameter and the group parameter, orientation data indicative of an orientation of at least one object amongst the first object and the objects; and
causing object detection data associated with the at least one object to be provided to a device based on the orientation data, wherein the object detection data is indicative of detection of one or more spatial features of the at least one object.

Example 44. The system of Example 43, wherein the operations further comprise:
obtaining, using the at least one processor, sensor data associated with the environment;
wherein determining the orientation data based on the map parameter and the group parameter comprises determining the orientation data is further based on the sensor data.

Example 45. The system of Example 44, wherein obtaining the group parameter comprises:
determining, distances between the objects based on the sensor data; and
clustering, based on the distances, the objects to form the group.

Example 46. The system of any of Examples 43-45, wherein the operations further comprise:
discarding, based on the group parameter and the map parameter, a group from the object detection data.

Example 47. The system of any of Examples 43-46, wherein determining, based on the map parameter and the group parameter, the orientation data comprises extracting, based on the sensor data and the group parameter, one or more line patterns associated with the first object and/or the objects.

Example 48. The system of Example 47, wherein determining, based on the map parameter and the group parameter, the orientation data comprises discarding, based on the one or more line patterns, one or more lines associated with the first object and/or the objects.

Example 49. The system of any of Examples 47-48, wherein determining, based on the map parameter and the group parameter, the orientation data comprises:
aligning, based on the one or more line patterns, at least one object amongst the first object and the objects; and
determining, based on the alignment, the orientation data.

Example 50. The system of any of Examples 43-49, wherein the operations further comprise:
improving, using the at least one processor, the object detection data with map layer information based on the map parameter and/or the group parameter.

Example 51. The system of any of Examples 43-50, wherein the operations further comprise:
performing, using the at least one processor, based on the group parameter, a non-maximum suppression scheme on the object detection data.

Example 52. The system of any of Examples 43-51, wherein the operations further comprise:
tracking, using the at least one processor, based on the orientation data and the sensor data, one or more objects in the environment.

Example 53. The system of any one of Examples 44-52, wherein the operations further comprise:
determining, using the at least one processor, based on the sensor data and the orientation data, control data for control of the autonomous vehicle.

Example 54. The system of any one of Examples 44-53, wherein the operations further comprise:
determining, using the at least one processor, based on the orientation data and the sensor data, a labelling of the at least one object in the environment.

Example 55. The system of any of Examples 43-54, wherein the operations further comprise:
updating, using the at least one processor, based on the orientation data, a machine-learning model.

Example 56. The system of Example 55, wherein updating the machine-learning model comprises:
inputting into the machine-learning model one or more of: the orientation data, one or more object parameters, the group parameter, and the map parameter;
outputting, from the machine-learning model, an updated orientation data; and recursively applying the updated orientation data in place of the orientation data.

Example 57. The system of any of Examples 43-56, wherein the operations further comprise:
obtaining, using the at least one processor, one or more estimated object parameters; comparing, using the at least one processor, the one or more estimated object parameters and the orientation data;
determining, using the at least one processor, based on the comparison, a differential parameter indicative of a difference in orientation between the one or more estimated object parameters and the orientation data; and
updating, using the at least one processor, based on the differential parameter, the orientation data.

Example 58. The system of any of Examples 43-57, wherein the operations further comprise:
estimating, using the at least one processor, based on the map parameter and/or the group parameter, a probability distribution of the orientation data; and
determining, using the at least one processor, based on the probability distribution of the orientation data, the object detection data.

Example 59. The system of any of Examples 43-58, wherein the operations further comprise:
determining, using the at least one processor, at least one ground-truth object in the environment based on the sensor data;
determining, using the at least one processor, an object orientation data indicative of ground-truth orientation of the at least one ground-truth object based on the sensor data;
determining, using the at least one processor, based on a comparison of the object orientation data and the orientation data, a confidence parameter indicative of a difference in orientation between the object orientation data and the orientation data; and
updating, using the at least one processor, the orientation data based on the confidence parameter.

Example 60. The system of any of Examples 43-59, wherein the map parameter is indicative of a region of the environment, and wherein the group parameter is indicative of the predetermined relation in the region.

Example 61. The system of any of Examples 43-60, wherein the first object is a first static object and the object is a second static object.

Example 62. The system of any of Examples 43-60, wherein the first object is a first moving object and the object is a second moving object.

Example 63. The system of any of Examples 43-62, the operations further comprising determining the object detection data based on the orientation data.

What is claimed is:

1. A method comprising:
obtaining, using at least one processor, a map parameter indicative of a predetermined position of a first object in an environment where an autonomous vehicle is configured to operate;
obtaining, using the at least one processor, a group parameter indicative of a predetermined relation between objects of a group, wherein the environment comprises the objects;
determining, using the at least one processor, orientation data indicative of an orientation of at least one object among the first object and the objects based on the map parameter and the group parameter; and
causing, using the at least one processor, object detection data associated with the at least one object to be provided to a device based on the orientation data, wherein the object detection data is indicative of detection of one or more spatial features of the at least one object.

2. The method of claim 1, further comprising:
obtaining, using the at least one processor, sensor data associated with the environment;
wherein determining the orientation data based on the map parameter and the group parameter comprises determining the orientation data based on the sensor data.

3. The method of claim 2, wherein obtaining the group parameter comprises:
determining, distances between the objects based on the sensor data; and
clustering, the objects to form the group based on the distances between the objects.

4. The method of claim 2, wherein determining the orientation data based on the map parameter and the group parameter comprises:
extracting one or more line patterns associated with the first object and/or the objects based on the sensor data and the group parameter.

5. The method of claim 4, wherein determining the orientation data based on the map parameter and the group parameter comprises:
discarding one or more lines associated with the first object and/or the objects based on the one or more line patterns.

6. The method of claim 4, wherein determining the orientation data based on the map parameter and the group parameter comprises:
aligning at least one object among the first object and the objects based on the one or more line patterns; and
determining the orientation data based on the alignment.

7. The method of claim 2, further comprising:
determining, using the at least one processor, at least one ground-truth object in the environment based on the sensor data;
determining, using the at least one processor, an object orientation data indicative of ground-truth orientation of the at least one ground-truth object based on the sensor data;
determining, using the at least one processor, a confidence parameter indicative of a difference in orientation between the object orientation data and the orientation data based on a comparison of the object orientation data and the orientation data; and
updating, using the at least one processor, the orientation data based on the confidence parameter.

8. The method of claim 1, further comprising:
discarding, based on the group parameter and the map parameter, a group from the object detection data.

9. The method of claim 1, further comprising:
improving, using the at least one processor, the object detection data with map layer information based on the map parameter and/or the group parameter.

10. The method of claim 1, further comprising:
performing, using the at least one processor, a non-maximum suppression scheme on the object detection data based on the group parameter.

11. The method of claim 2, further comprising:
tracking, using the at least one processor, one or more objects in the environment based on the orientation data and the sensor data.

12. The method of claim 2, further comprising:
determining, using the at least one processor, control data for control of the autonomous vehicle based on the sensor data and the orientation data.

13. The method of claim 2, further comprising:
determining, using the at least one processor, a labelling of the at least one object in the environment based on the orientation data and the sensor data.

14. The method of claim 1, further comprising:
updating, using the at least one processor, a machine-learning model based on the orientation data.

15. The method of claim 14, wherein updating the machine-learning model comprises:
inputting into the machine-learning model one or more of: the orientation data, one or more object parameters, the group parameter, and the map parameter;
outputting, updated orientation data from the machine-learning model; and
recursively applying the updated orientation data in place of the orientation data.

16. The method of claim 1, further comprising:
obtaining, using the at least one processor, one or more estimated object parameters;
comparing, using the at least one processor, the one or more estimated object parameters and the orientation data;
determining, using the at least one processor, a differential parameter indicative of a difference in orientation between the one or more estimated object parameters and the orientation data based on the comparing; and
updating, using the at least one processor, the orientation data based on the differential parameter.

17. The method of claim 1, further comprising:
estimating, using the at least one processor, a probability distribution of the orientation data based on the map parameter and/or the group parameter; and
determining, using the at least one processor, the object detection data based on the probability distribution of the orientation data.

18. The method claim 1, further comprising:
determining, using the at least one processor, the object detection data based on the orientation data.

19. A non-transitory computer readable medium comprising instructions stored thereon that, when executed by at least one processor, cause the at least one processor to carry out operations comprising:
obtaining a map parameter indicative of a predetermined position of a first object in an environment where an autonomous vehicle is configured to operate;
obtaining a group parameter indicative of a predetermined relation between objects of a group, wherein the environment comprises the objects;
determining, orientation data indicative of an orientation of at least one object amongst the first object and the objects based on the map parameter and the group parameter; and
causing object detection data associated with the at least one object to be provided to a device based on the orientation data, wherein the object detection data indicative of detection of one or more spatial features of the at least one object.

20. A system, comprising at least one processor and at least one memory storing instructions thereon that, when executed by the at least one processor, cause the at least one processor to perform operations comprising:
obtaining a map parameter indicative of a predetermined position of a first object in an environment where an autonomous vehicle is configured to operate;
obtaining a group parameter indicative of a predetermined relation between second objects of a group, wherein the environment comprises the second objects;
determining based on the map parameter and the group parameter, orientation data indicative of an orientation of at least one object amongst the first object and the second objects; and
causing object detection data associated with the at least one object to be provided to a device based on the orientation data, wherein the object detection data indicative of detection of one or more spatial features of the at least one object.
